(19) United States
(12) Patent Application Publication
(10) Pub. No.: US 2016/0080424 A1
(43) Pub. Date: Mar. 17, 2016

(54) APPARATUS AND METHOD FOR REESTABLISHING A SECURITY ASSOCIATION USED FOR COMMUNICATION BETWEEN COMMUNICATION DEVICES

(71) Applicant: FUJITSU LIMITED, Kawasaki-shi (JP)

(72) Inventors: Mariko HASEGAWA, Oota (JP); Hiroyasu TAGUCHI, Kawasaki (JP)

(21) Appl. No.: 14/848,050

(22) Filed: Sep. 8, 2015

(30) Foreign Application Priority Data
Sep. 12, 2014 (JP) 2014-186656

(51) Int. Cl. H04L 29/06; H04W 12/08

(52) U.S. Cl. CPC H04L 63/20; H04W 12/08

(57) ABSTRACT

A communication apparatus monitors a communication situation of a communication performed using each of a plurality of security associations established between the communication apparatus and a counterpart apparatus, and stores information indicating the communication situation. When a first security association in the plurality of security associations is disconnected, the communication apparatus determines whether the counterpart apparatus uses the disconnected first security association, based on the information. When the counterpart apparatus uses the first security association, the communication apparatus reestablishes a second security association which supersedes the first security association.

### CROSS-REFERENCE TO RELATED APPLICATION

This application is based upon and claims the benefit of priority from the prior Japanese Patent Application No. 2014-186656 filed on Sep. 12, 2014, the entire contents of which are incorporated herein by reference.

### FIELD

The embodiments discussed herein are related to apparatus and method for reestablishing a security association used for communication between communication devices.

### BACKGROUND

There has been known a Security Architecture for Internet Protocol (IPsec) as an architecture which provides prevention of data falsification or data secrecy in unit of an Internet Protocol (IP) packet by using an encryption technology. In the IPsec, a packet is transferred using a security association (SA). The SA is a connection for providing a security service to communication traffics delivered through the SA.

There has been a method of automatically generating and managing the SA by using an automatic key management protocol (referred to as a “key exchange protocol”) as an SA management method. The key exchange protocol is referred to as an Internet Key Exchange protocol (IKE). The IKE includes IKE version 1 (IKEv1) defined in, for example, RFC 2409, and IKE version 2 (IKEv2) defined in RFC 4306. There is no compatibility between the IKEv1 and the IKEv2.

For example, an SA used for a key exchange is established first between two counterpart apparatuses (peers) in the IKEv2. The SA is referred to as “IKE_SA.” Next, a key exchange is performed for establishing an IPsec SA (that is, SA for protecting a communication made using a security protocol) by using the IKE_SA. In the IPsec, the security protocols referred to as Authentication Header (AH) and Encapsulated Security Payload (ESP) are defined. The AH provides header authentication and the ESP provides payload encryption such that the communication is protected. However, a single security protocol is applied to a single SA and one of the AH and the ESP is applied to the SA. The IPsec SA is referred to as “CHILD_SA” in the IKEv2.

A lifetime is set for the SA (IKE_SA and CHILD_SA). The lifetime includes a hard lifetime and a soft lifetime. The hard lifetime indicates a time limit of the SA, and when the hard lifetime expires, the SA is abandoned and the communication using the SA becomes non-executable. In contrast, the soft lifetime expires before expiration of the hard lifetime. When the soft lifetime expires, a reestablishment of the SA using the existing IKE_SA is conducted and the SA is maintained. Accordingly, the soft lifetime is set to be expired before the expiration of the hard lifetime. The reestablishment (update of CHILD_SA) of the SA using the existing IKE_SA is referred to as “rekeying”. The operation at the time of the expiration of the soft lifetime depends on a security policy (SP) of the apparatus. In the present disclosure, a notation of “lifetime” refers to the soft lifetime.

In the IKEv1, a negotiation of the SA lifetime is conducted between the apparatuses (peers). In contrast, the negotiation of the SA lifetime is not conducted in the IKEv2. Accordingly, each apparatus may independently (without depending on the counterpart) set a desired lifetime for the SA. As a result, different lengths of the lifetime may be set for the respective apparatuses.

Further, the IPsec has a function referred to as a Dead Peer Detection (DPD). The DPD is a function of detecting that the IPsec communication is disconnected, that is, detecting disconnection of the SA. Specifically, one of two established apparatuses sends a confirmation message (referred to as a DPD message) to the other of two established apparatuses. When a response message to the DPD message is received, the one of two established apparatuses determines that the IPsec communication is normal and otherwise, when the DPD message is not received, the one of two established apparatuses determines that the IPsec communication is disconnected.

Related technologies are disclosed in, for example, Japanese Laid-Open Patent Publication No. 2008-205763, Japanese Laid-Open Patent Publication No. 2008-245158, Japanese Laid-Open Patent Publication No. 2005-20215, Japanese Laid-Open Patent Publication No. 2008-301072, and Japanese Laid-Open Patent Publication No. 2012-191277.

### SUMMARY

According to an aspect of the invention, a communication apparatus monitors a communication situation of a communication performed using each of a plurality of security associations established between the communication apparatus and a counterpart apparatus, and stores information indicating the communication situation. When a first security association in the plurality of security associations is disconnected, the communication apparatus determines whether the counterpart apparatus uses the disconnected first security association, based on the information. When the counterpart apparatus uses the first security association, the communication apparatus reestablishes a second security association which supersedes the first security association.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a sequence diagram for explaining a reference example;

FIG. 2 is another sequence diagram for explaining the reference example;

FIG. 3 is a diagram illustrating an example of an operational sequence for a communication control method of a base station (communication apparatus), according to an embodiment;

FIG. 4 is a diagram illustrating an example of an operational sequence for a communication control method of a base station (communication apparatus), according to an embodiment;

FIG. 5 is a diagram illustrating an example of an operational sequence for a communication control method of a base station (communication apparatus), according to an embodiment;

FIG. 6A is a diagram illustrating an example of an operational sequence for a communication control method of a base station (communication apparatus), according to an embodiment;

FIG. 6B is a diagram illustrating an example of data structures of an SA information table and an SA information preservation table provided in a base station (communication apparatus), according to an embodiment;

FIG. 6C is a diagram illustrating an example of data structures of an SA information table and an SA information preservation table provided in a base station (communication apparatus), according to an embodiment;

FIG. 7 is a diagram illustrating an example of a network configuration of a communication control system, according to an embodiment;

FIG. 8 is a diagram illustrating an example of a hardware configuration of a base station, according to an embodiment;

FIG. 9 is a diagram illustrating an example of functionalities of an NP provided in a base station, according to an embodiment;

FIG. 10 is a diagram illustrating an example of a data structure of an SA information management table, according to an embodiment;

FIG. 11 is a diagram illustrating an example of a data structure of a preserving management table, according to an embodiment;

FIG. 12 is a diagram illustrating an example of an operational flowchart for operation and management of a base station, according to an embodiment;

FIG. 13 is a diagram illustrating an example of an operational flowchart for a first table update process (table update #1) in a base station, according to an embodiment;

FIG. 14 is a diagram illustrating an example of an operational flowchart for a second table update process (table update #2) in a base station, according to an embodiment;

FIG. 15 is a diagram illustrating an example of an operational flowchart for a first counterpart apparatus monitoring process (counterpart apparatus monitoring #1) in a base station, according to an embodiment;

FIG. 16 is a diagram illustrating an example of an operational flowchart for a second counterpart apparatus monitoring process (counterpart apparatus monitoring #2), according to an embodiment;

FIG. 17 is a diagram illustrating an example of an operational flowchart for a second counterpart apparatus monitoring process (counterpart apparatus monitoring #2), according to an embodiment;

FIG. 18 is a diagram illustrating an example of an operational flowchart for a second counterpart apparatus monitoring process (counterpart apparatus monitoring #2), according to an embodiment; and

FIG. 19 is a diagram illustrating an example of an operational flowchart for an SA deletion post-process, according to an embodiment.

### DESCRIPTION OF EMBODIMENTS

A plurality of SAs (e.g., SA1 and SA2) may be established between two counterpart apparatuses for an IP packet flow, based on the IKEv2. In this case, a negotiation of which one of the SA1 and the SA2 is to be used is not conducted between one apparatus (assumed as an apparatus 1) and the other apparatus (assumed as an apparatus 2) and each of the apparatus 1 and the apparatus 2 transmits the packet by using one of the SA1 and SA2 determined independently.

In a situation described above, a case is assumed where the apparatus 2 does not respond to, for example, a DPD message with respect to the SA2 transmitted from the apparatus 1 for some reason and the apparatus 1 has detected the disconnection of the SA2. In this case, when other SA established between the apparatus 1 and the apparatus 2 is not present, the apparatus 1 abandons the disconnected SA2 and requests the apparatus 2 to abandon the SA2. Then, the apparatus 1 establishes a new SA for the apparatus 2. In contrast, when the other SA is present, the apparatus 1 expects the communication using the other SA and abandons the SA2, but does not conduct an establishment of a new SA.

In the meantime, a case may occur in which the apparatus 2 is in a status where the SA2 is maintained and the packet is transmitted to the apparatus 1 by using the SA2 regardless of the abandonment of the SA2 in the apparatus 1. In this case, since the apparatus 1 has abandoned the SA2, the apparatus 1 is not able to decrypt or authenticate the packet transmitted using the SA2 from the apparatus 2. Therefore, the apparatus 1 abandons the packet. The apparatus 1 executes rekeying of the SA1 so as to release the status described above, when the SA between the apparatus 1 and the apparatus 2 becomes non-existent due to, for example, the expiration of the lifetime of the SA1 in the apparatus 1. This is because the apparatus 2 is adapted to make communication using the last established SA, and uses the reestablished SA as a SA used for the communication, when rekeying (reestablishment of SA) is executed for the SA1.

The timing at which the status is released depends on an expiration time of the lifetime set for the SA1 by the apparatus 1 and an expiration time of the lifetime set for each of the SA1 and SA2 by the apparatus 2. This is because the reestablishment of the SA according to the detection of the disconnection of communication by the DPD is an exceptional processing and the reestablishment of the SA is normally conducted by rekeying according to the expiration of the lifetime.

Here, for example, when the expiration time of the lifetime set for each of the SA1 and the SA2 by the apparatus 2 is later than the expiration time of the lifetime set for the SA1 by the apparatus 1, the status described above is continued to the time at which the lifetime of the SA1 in apparatus 1 expires. As described above, when the time spanning from abandonment of the SA2 to the expiration of the lifetime of the SA1 in the apparatus 1 is long, there was a concern that an abnormal status where the apparatus 1 is unable to receive the packet from the apparatus 2 is continued for a long period of time.

Hereinafter, descriptions will be made on an embodiment with reference to accompanying drawings. A configuration of the embodiment is illustrative only and is not limited to the illustrated configuration.

### Reference Example

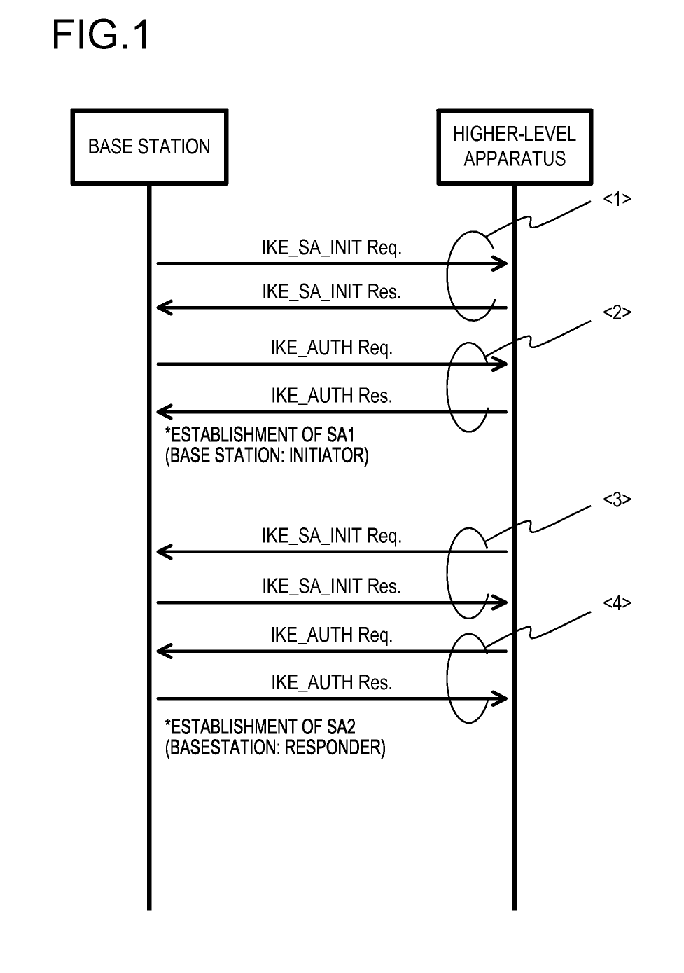

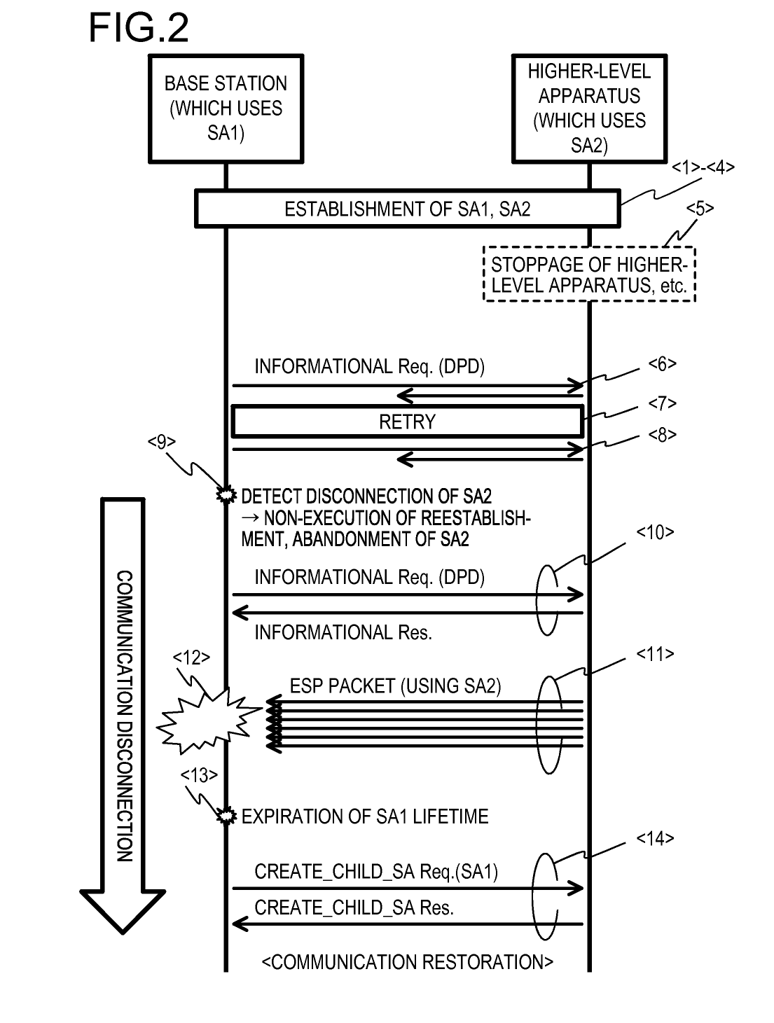

Before describing the embodiment, a reference example will be described with reference to FIG. 1 and FIG. 2 and problems to be solved in the embodiment will be described. FIG. 1 and FIG. 2 are sequence diagrams for explaining a reference example. In FIG. 1 and FIG. 2, a base station and a higher-level apparatus of the base station are illustrated as a set of communication apparatuses or communication equipment (peers) that make a communication with each other by using the IPsec. The higher-level apparatus is a counterpart apparatus of the base station when judging from the base station, and the base station is a counterpart apparatus of the higher-level apparatus when judging from the higher-level apparatus.

As illustrated in FIG. 1, prior to making a communication using the IPsec, the base station and the higher-level apparatus execute an establishment procedure for the IPsec SA by using the IKEv2 (hereinafter, simply denoted as “IKE”). For example, the base station serves as an initiator of the IKE and the higher-level apparatus serves as a responder.

The base station which is the initiator sends a message “IKE_SA_INIT request”, and the higher-level apparatus which is the responder replies with a message “IKE_SA_INIT response”. In the exchange of the message, a negotiation of parameters of the IKE_SA and exchange of parameters used for computing the key is conducted between the base station and the higher-level apparatus so that the IKE_SA is generated (established) (<1> of FIG. 1).

Next, the base station sends a message “IKE_AUTH request”, and the higher-level apparatus replies with a message “IKE_AUTH response”. With the exchange of the message, the communication counterpart is authenticated and, at the same time, a negotiation of parameters used for the CHILD_SA and an exchange of parameters used for computing the key are conducted so that the CHILD_SA is generated (established) (<2> of FIG. 1). In the meantime, the exchange of the message “IKE_AUTH” is executed in a secure status of being encrypted using the key of the IKE_SA.

With the establishment of the CHILD_SA, the IPsec communication using the security protocol (e.g., AH or ESP) determined by the negotiation becomes executable between the counterpart apparatuses. In the following, descriptions will be made on a case where the security protocol is the ESP. However, the AH may be used as the security protocol and a protocol other than the AH and ESP may be used.

In the example illustrated in FIG. 1, the base station serves as the initiator and SAs (IKE_SA and CHILD_SA) are established between the base station and the higher-level apparatus (<1> and <2> of FIG. 1). The SAs are referred to as “SA1.” In this case, there may be a case where the higher-level apparatus serves as the initiator and other SAs are established between the base station and the higher-level apparatus (<3> and <4> of FIG. 1). The SAs are referred to as “SA2.”

The SA1 and the SA2 have a value (identifier) uniquely identifying an SA referred to as a security parameter index (SPI). Even though the SA1 and SA2 have the value, since the SA is a unidirectional connection, two SPI values each of which corresponds to each direction are set for a bidirectional communication. That is, the SA1 is, strictly speaking, a pair of SAs formed of an SA directing from the higher-level apparatus to the base station (that is, higher-level apparatus- ->base station direction) (downstream direction) and an SA directing from the base station to the higher-level apparatus (that is, base station- ->higher-level apparatus direction) (upstream direction), and a different SPI value is set for each direction. For example, the SPI value for the downstream direction of the SA1 is “0x00000100” and the SPI value for the upstream direction of the SA1 is “0x00000101.” Further, the SA2 is a pair of an SA of the downstream direction (e.g., SPI value of “0x00000102”) and an SA of the upstream direction (e.g., SPI value of “0x00000103”).

As described above, when a plurality of SAs (SA1 and SA2) are established between the base station and the higher-level apparatus, the base station and the higher-level apparatus may independently set the SA to be used for the communication (packet transmission) as having been described above. In the reference example illustrated in FIG. 1 and FIG. 2, the base station uses the SA1 and the higher-level apparatus uses the SA2. Further, the base station and the higher-level apparatus may independently set the lifetimes for the SA1 and the SA2. It is assumed that the lifetimes of the SA1 and the SA2 in the higher-level apparatus are longer than the lifetimes for the SA1 and the SA2 set in the base station. Since negotiation of the lifetime is not conducted, the base station and the higher-level apparatus do not know the lifetimes for the SA1 and the SA2 set by the counterpart apparatus.

Under the situation described above, a problem as illustrated in FIG. 2 is likely to occur. As illustrated in FIG. 2, a case where the SA1 and SA2 have been established between the base station and the higher-level apparatus through the procedure of <1> to <4> illustrated in FIG. 1 is assumed (<1> to <4> of FIG. 2).

Then, for example, it is assumed that the base station and the higher-level apparatus are placed temporarily in a situation where both are not able to communicate with each other due to a factor, such as a temporary operation stop (fault or execution of maintenance) of the higher-level apparatus, or maintenance of a packet relaying apparatus disposed between the base station and the higher-level apparatus (<5> of FIG. 2).

This causes a situation where the base station is unable to receive a response from the higher-level apparatus with respect to the DPD message (INFORMATIONAL request) for the SA2 transmitted by the base station to the higher-level apparatus (<6> of FIG. 2). For example, a case is assumed where the DPD message is not normally transmitted and received due to a temporary fault of the relay apparatus even though the higher-level apparatus is in a normal state.

The base station retries the DPD message transmission a predetermined number of times (<7> of FIG. 2). However, in a case where the response is not obtained from the higher-level apparatus even by the retrial (<8> of FIG. 2), it is determined that the communication for the SA2 is disconnected (<9> of FIG. 2). In other words, the base station detects disconnection of the communication over the SA2.

In this case, the base station does not conduct the reestablishment of an SA which supersedes the SA2 and abandons the SA2 on the grounds that there exists the SA1 being established (connected) between the base station and the higher-level apparatus. The abandonment of SA means that information regarding the SA (referred to as SA parameters) is deleted from, for example, a Security Association Database (SAD) which manages the SA. The SA parameters include, for example, a mode (tunnel mode, transport mode), an SPI value, a type of security protocol used in the SA, and a value of key used in the security protocol. The security protocol includes an authentication protocol (e.g., AH) or encryption protocol (e.g., ESP).

Since the higher-level apparatus is in a normal state, the higher-level apparatus responds to the DPD message that is transmitted from the base station for the SA1 (<10> of FIG. 2). Accordingly, the base station does not execute rekeying according to the disconnection of the communication over the SA1 by the DPD with respect to the SA1.

In the meantime, since the higher-level apparatus is in a normal state, the higher-level apparatus transmits a packet (ESP packet) destined to the base station by using the SA2 (<11> of FIG. 2). However, since the base station has abandoned the SA2, the base station is not able to decrypt the ESP packet and abandons the ESP packet (<12> of FIG. 2).

As having described above, the expiration timings of the lifetimes of the SA1 and the SA2 in the higher-level apparatus are later than the expiration timing of the lifetime of the SA1 in the base station. Accordingly, rekeying of the SA1 and the SA2 from the higher-level apparatus is not executed. Therefore, until the lifetime of the SA1 expires in the base station, an abnormal state continues where the packet transmitted from the higher-level apparatus using the SA2 is unable to be received, that is, an abnormal status of a communication continues, in the base station.

When the lifetime of the SA1 expires in the base station (<13> of FIG. 2), the base station enters a state where there exists no SA being established with the higher-level apparatus. Accordingly, the base station executes rekeying for the SA1 (<14> of FIG. 2). The rekeying is executed in the following sequence. That is, the base station sends a message “CREATE_CHILD_SA request” for updating (reestablishment of SA) the key of the SA1 to the higher-level apparatus by using an IKE_SA1. The higher-level apparatus replies a response message “CREATE_CHILD_SA response”. With the exchange of the message “CREATE_CHILD_SA”, the key of the SA1 is updated and the SA1 is reestablished. In this case, the higher-level apparatus is placed in a state of using the latest SA1 for making communication (packet transmission) with the base station. Accordingly, the base station becomes able to receive the ESP packet by decrypting the ESP packet transmitted from the higher-level apparatus using the SA1. That is, the communication is restored between the base station and the higher-level apparatus.

However, when the lifetime of the SA1 is a long period of time (e.g., several hours) in the base station, a state where a normal communication is not made (an abnormal status) is continued for a long period of time. In the embodiment which will be described in the below, descriptions will be made on a technology capable of enabling early restoration from the abnormal status described above.

In the embodiment, the base station monitors a communication situation regarding a plurality of SAs established with the higher-level apparatus, and stores information indicating the communication situation. The “plurality of SAs” means two or more SAs. When one of the plurality of SAs is disconnected, the base station determines whether the disconnected SA is the SA being used for the communication by the counterpart apparatus, based on the information indicating the communication situation. In this case, when it is determined that the disconnected SA is a SA being used for the communication by the counterpart apparatus, the base station conducts the reestablishment of the SA which supersedes the SA for which the disconnection is detected.

The reestablishment may be conducted by either rekeying (update of CHILD_SA) any one of the plurality of SAs or establishing a new SA (re-creation of IKE_SA and CHILD_SA). An SA to be rekeyed may be the SA for which a disconnection is detected and one of SAs being established (remaining SAs except for the SA for which disconnection is detected among the plurality of SAs). When the establishment of the new SA or rekeying for the remaining SAs is executed, the SA for which a disconnection is detected may be either abandoned or not be abandoned.

With the reestablishment of the SA, the base station and the higher-level apparatus are placed in a state of making communications using the reestablished SA. Accordingly, it becomes possible to restore the communication to a normal status at an earlier time than a case of being waited until the lifetime of the SA other than the disconnected SA expires in the base station.

The base station which will be described in the following embodiment is an example of a “communication apparatus” and the higher-level apparatus is an example of a “counterpart apparatus”. However, when an expression of “between counterpart apparatuses” is used, each of the base station and the higher-level apparatus corresponds to the “counterpart apparatus”. Further, the base station corresponds to the “counterpart apparatus” judging from the higher-level apparatus. In the meantime, the “communication apparatus” and the “counterpart apparatus” are not limited to the base station and the higher-level apparatus. For example, all of the communication apparatuses and the communication equipment that form the peers (a set of communication apparatuses or communication equipment) between which the SA is established and the communication using the IPsec is made, correspond to “communication apparatus” and the “counterpart apparatus”.

### Embodiment 1

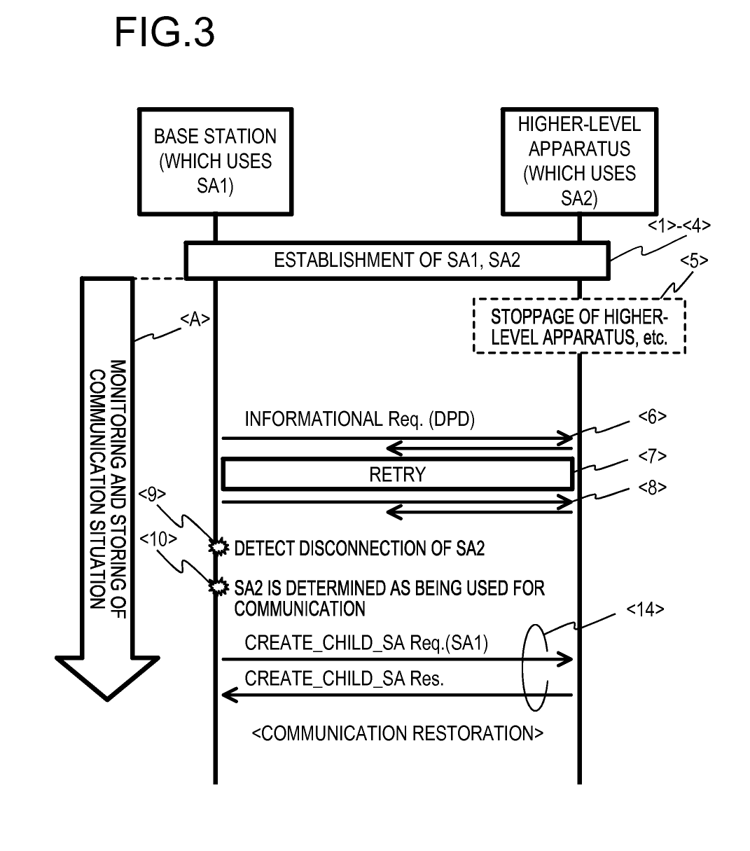

FIG. 3 is a sequence diagram for explaining a communication control method of a base station (communication apparatus) according to Embodiment 1. In Embodiment 1, operations from <1> to <9> illustrated in FIG. 3 are the same as those of <1> to <9> in the reference example (FIG. 2). That is, it is assumed that FIG. 3 illustrates a status where the SA1 and the SA2 are established between the base station and the higher-level apparatus (<1> to <4> of FIG. 3), the base station uses the SA1, and the higher-level apparatus uses the SA2, similarly as in the reference example (FIG. 2).

However, in Embodiment 1, the base station starts monitoring a communication situation for each of the SA1 and SA2 according to the establishment of the SA1 and the SA2, and stores information indicating the communication situation (<A> of FIG. 3). Next, in a case where the base station is not able to receive a response message from the higher-level apparatus (<6> to <8> of FIG. 3) even when the DPD message is transmitted to the higher-level apparatus, the base station detects disconnection of the SA2 (<9> of FIG. 3). The transmission of the DPD message may be regularly executed and otherwise, executed by a trigger input to the base station.

In Embodiment 1, when the disconnection of the SA2 is detected, the base station determines whether the detected SA2 is a SA used for the communication by the higher-level apparatus, based on the information indicating the communication situation, differently from the reference example. For example, the information indicating the communication situation is transmitted from the higher-level apparatus by using the SA2 and includes information indicating the number of packets received in the base station.

When it is determined from the information indicating the communication situation that the SA2 is used by the higher-level apparatus (<10> of FIG. 3), the base station executes rekeying of the SA1 without waiting for the expiration of the lifetime of the SA1 (<11> of FIG. 3). Accordingly, the higher-level apparatus is placed in a status of using the SA1 reestablished (updated) by the rekeying when transmitting the packet to the base station. Accordingly, the communication may be restored to a normal state at an earlier time than a case of being waited until the lifetime of the SA expires (reference example).

In the meantime, in Embodiment 1, the SA2 may be deleted from both of the base station and the higher-level apparatus before and after the execution of rekeying of the SA1. Further, the base station may execute rekeying of the SA2 instead of the SA1. In this case, the base station and the higher-level apparatus are placed in a state where the reestablished (updated) SA2 is used for the communication (packet transmission) by the rekeying of the SA2. Even when the reestablished SA2 is used for the communication, since the base station is placed in a state of capable of normally receiving the packet from the higher-level apparatus by using the information of the reestablished SA2, the communication may be restored.

### Embodiment 2

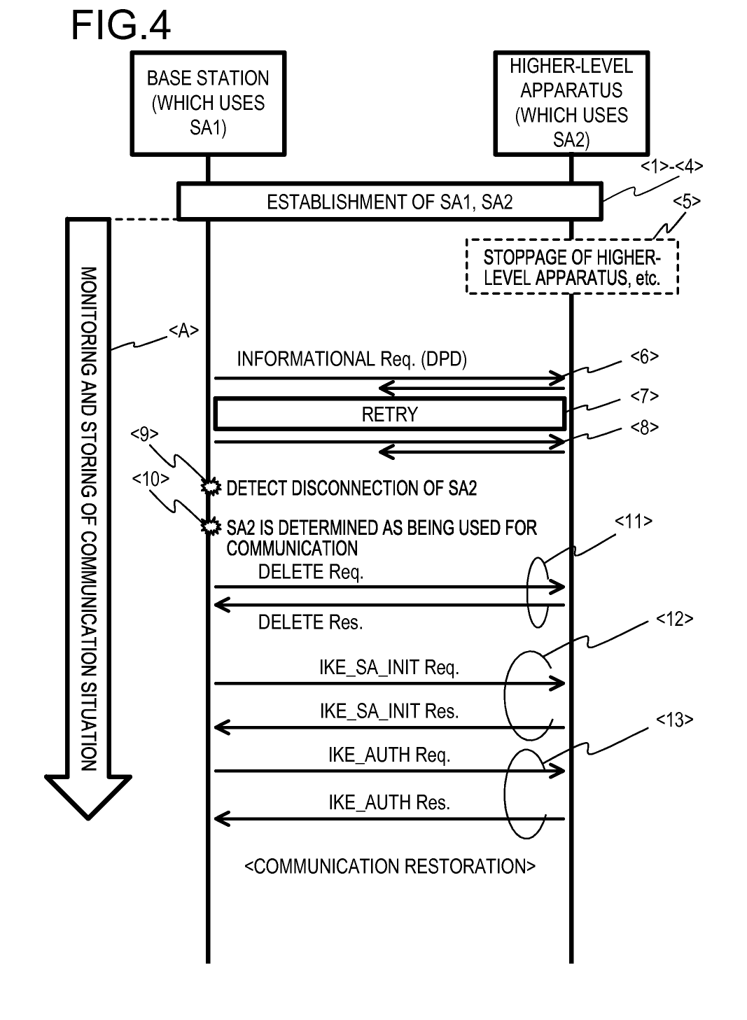

FIG. 4 is a sequence diagram for explaining a communication control method of a base station (communication apparatus) according to Embodiment 2. In Embodiment 2, operations from <1> to <9> illustrated in FIG. 3 are the same as those of <1> to <9> in the reference example (FIG. 2). However, in Embodiment 2, the base station starts monitoring a communication situation for each of the SA1 and SA2 according to the establishment of the SA1 and the SA2, and stores information indicating the communication situation (<A> of FIG. 4), similarly as in Embodiment 1.

In Embodiment 2, when the disconnection of the SA2 is detected (<9> of FIG. 4), the base station determines whether the detected SA2 is a SA used for the communication by the higher-level apparatus, based on the information indicating the communication situation, similarly as in Embodiment 1. When it is determined from the information indicating the communication situation that the SA2 is used by the higher-level apparatus (<10> of FIG. 4), the base station abandons the SA2 within the base station. In the meantime, the base station transmits an abandonment request message “DELETE request” for the SA2 to the higher-level apparatus, and receives a response message “DELETE response” from the higher-level apparatus (<11> of FIG. 4). The higher-level apparatus which has received the abandonment request message abandons the SA2 according to the request.

Next, the base station executes an establishment procedure of a new SA with the higher-level apparatus (<12> and <13> of FIG. 4). Accordingly, the base station and the higher-level apparatus are placed in a state of making a communication with each other using the reestablished new SA and the communication is restored. Also, in Embodiment 2, the communication may be restored to a normal state at an earlier time than a case of being waited until the lifetime of the SA1 expires (reference example).

In the meantime, an abandonment of the SA2 is exemplified in the example illustrated in FIG. 4. Instead of the abandonment of the SA2, even when the SA1 is abandoned or the SA1 and SA2 are abandoned, an effect of restoration to the normal state by the establishment of new SA may be obtained.

### Embodiment 3

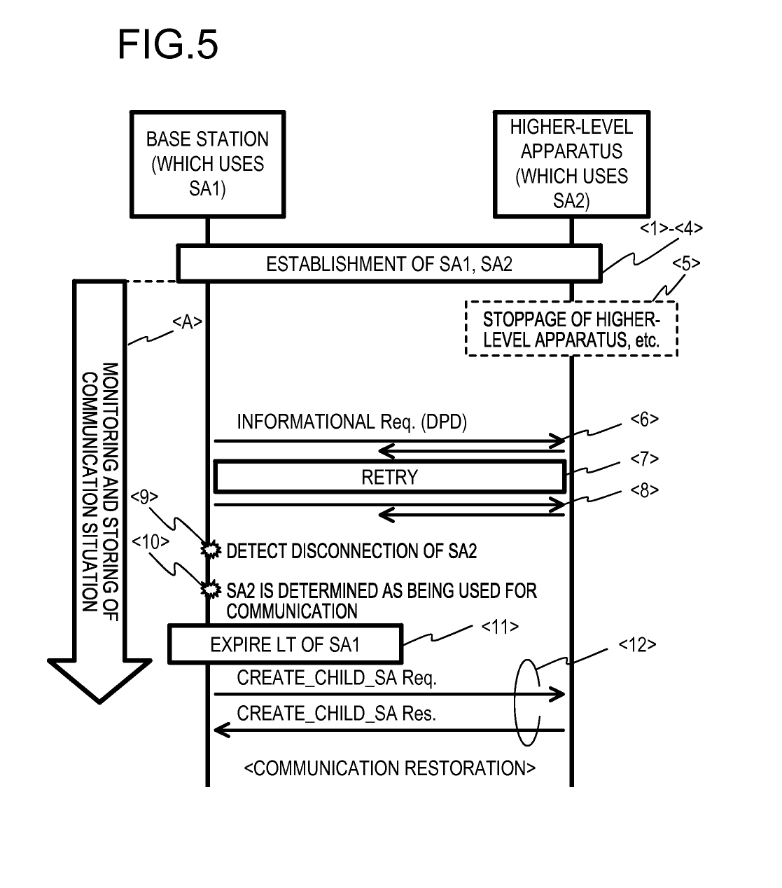

FIG. 5 is a sequence diagram for explaining a communication control method of a base station (communication apparatus) according to Embodiment 3. The operations from <1> to <10> illustrated in FIG. 5 are the same as those of <1> to <10> in Embodiment 1 or Embodiment 2. However, in Embodiment 2, the base station starts monitoring a communication situation for each of the SA1 and the SA2 according to the establishment of the SA1 and the SA2, and stores information indicating the communication situation (<A> of FIG. 5), similarly as in Embodiment 1 and Embodiment 2.

In Embodiment 3, when it is determined that the higher-level apparatus uses the SA2 detected as being disconnected, the base station abandons the SA2, and forcibly expires the lifetime (LT) of the SA1 (<11> of FIG. 5). The base station may reduce the lifetime of the SA1 instead of the forcible expiration.

When the lifetime of the SA1 expires, the base station executes rekeying of the SA1 (<12> of FIG. 5). Accordingly, the higher-level apparatus enters in a state of making communication using the reestablished (updated) SA1 such that the communication is restored to a normal status. In the meantime, the lifetime of the SA2, instead of the SA1, may be forcibly expired or reduced.

### Embodiment 4

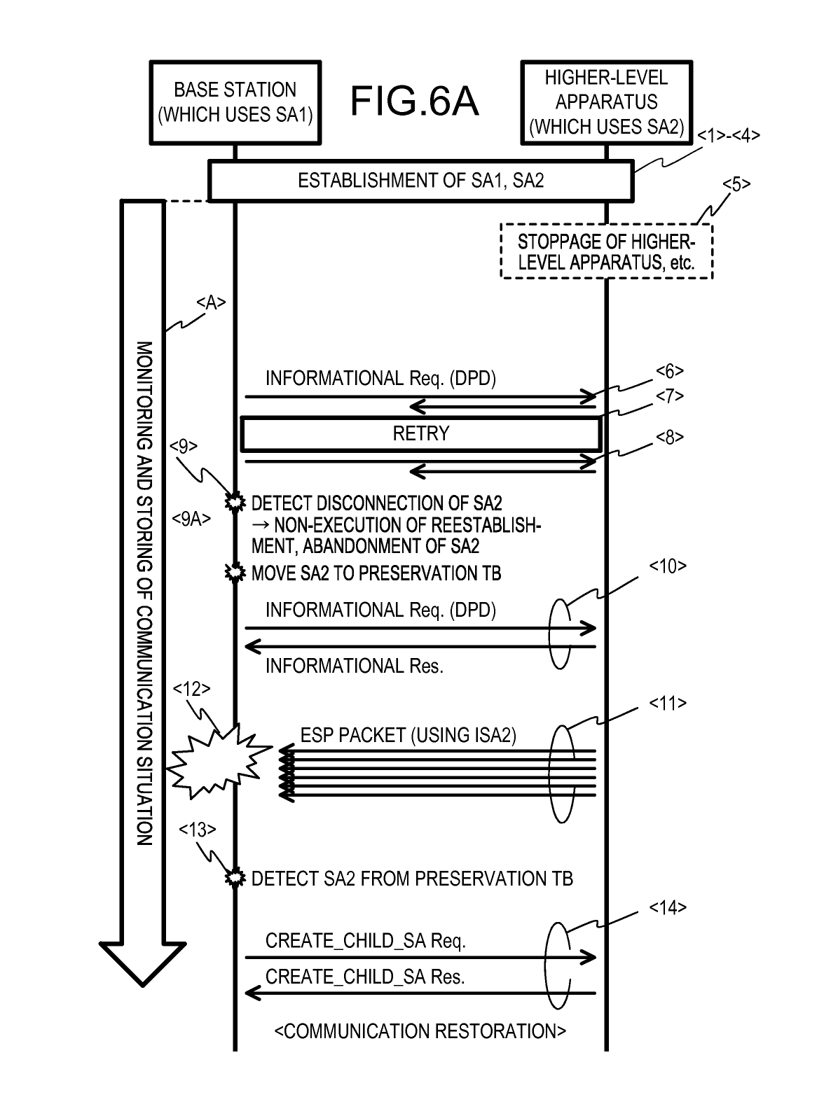

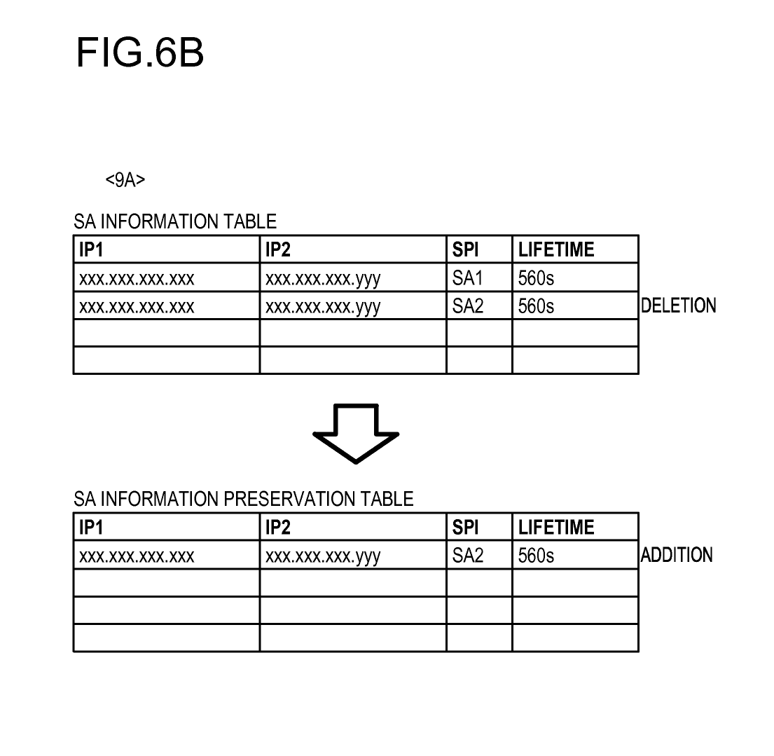

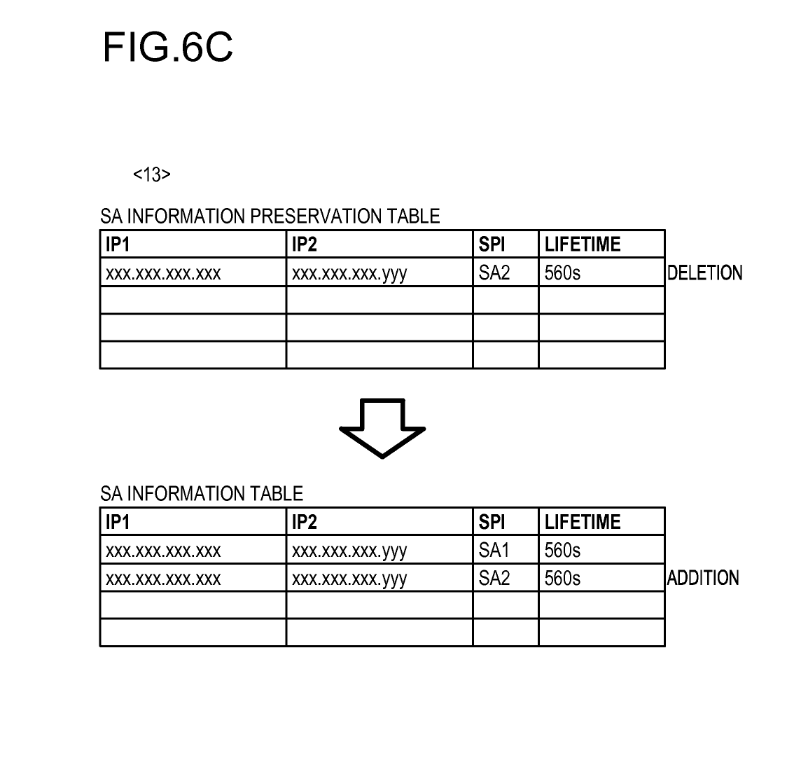

FIG. 6A, FIG. 6B, and FIG. 6C are sequence diagrams for explaining a communication control method of a base station (communication apparatus) according to Embodiment 4. The operations from <1> to <9> illustrated in FIG. 6A are the same as those in each of Embodiment 1, Embodiment 2, and Embodiment 3. Further, the base station starts monitoring a communication situation for each of the SA1 and the SA2 according to the establishment of the SA1 and the SA2, and stores information indicating the communication situation (<A> of FIG. 6A), similarly as in Embodiment 1, Embodiment 2 and Embodiment 3. Further, in Embodiment 4, as illustrated in FIG. 6B and FIG. 6C, the base station stores an SA information table which stores information about the SA1 and the SA2 and an SA information preservation table which temporarily stores information deleted from the SA information table.

In FIG. 6B, the SA information table stores, for example, an IP address of the base station (IP1), an IP address of the higher-level apparatus (IP2), an SPI indicating the SA established between the IP addresses (SA1, SA2), and the lifetime of each of the SA1 and the SA2. However, a data structure of the SA information table is illustrative only and is not limited to the contents of FIG. 6B. A data structure of the SA information preservation table is the same as that of the SA information table.

When the base station detects the disconnection of the SA2 and intends to abandon the SA2 without executing rekeying of the SA2, the base station deletes information (entry) of the SA2 from the SA information table and adds (moves) the information to the SA information preservation table (see <9A> of FIG. 6A and FIG. 6B).

As illustrated in <11> of FIG. 6A, after the entry of the SA2 is stored in the SA information preservation table, the packet (ESP packet) sent from the higher-level apparatus using the SA2 is received in the base station. The base station extracts the SPI from the received packet and determines whether the entry related to the SPI is stored in the SA information preservation table. When the entry of the SA2 is detected from the SA information preservation table (<13> of FIG. 6A), the base station moves the entry into the SA information table (see FIG. 6C) and executes rekeying of the SA2 (<14> of FIG. 6A). Accordingly, the base station and the higher-level apparatus are placed in a state of capable of making a communication with each other using the SA2 reestablished by rekeying. That is, the communication is restored.

### Embodiment 5

Next, Embodiment 5 will be described. The network configuration or the base station configuration in Embodiment 5 may be applied to execute the communication control method illustrated in Embodiments 1 to 4.

<Network Configuration>

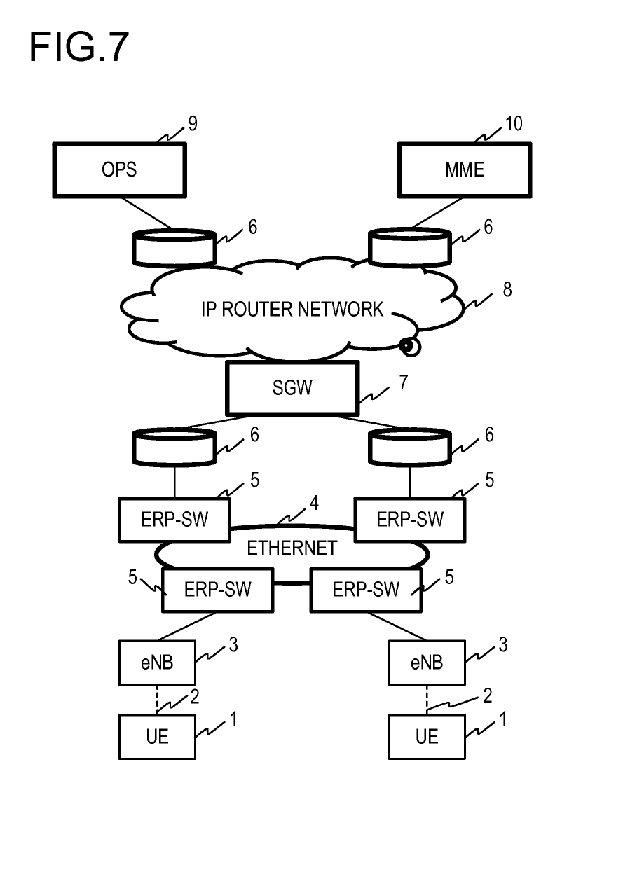

FIG. 7 is a diagram illustrating an example of a network configuration of a communication control system in Embodiment 5. In FIG. 7, a wireless terminal (UE: User Equipment) 1 connects to a base station (eNB) 3 through a wireless link 2. The base station 3 connects to the Ethernet (LAN) 4. For example, the Ethernet 4 is formed in a ring network constituted by a plurality of Ethernet transmission apparatuses (ERP-SWs: Ethernet Ring Protection switches) 5. The ERP-SW 5 is a type of a layer 2 switch.

Some ERP-SWs of the ERP-SWs 5 connect to a security gateway (SGW) 7 through routers 6. However, an architecture in which the Ethernet 4 is formed in the ring network constituted by the ESP-SWs 5 or the Ethernet 4 and the router 6 are disposed between the base station 3 and SGW 7 is not an essential configuration in implementing the network configuration of the communication control system. The ERP-SW 5 and the router 6 are examples of the “relay apparatus.”

The SGW 7 is a higher-level apparatus of the base station 3 and is a counterpart apparatus of the base station 3, which makes communication with the base station by using the IPsec. The SGW 7 connects to an IP router network 8 including a plurality of routers 6.

A network operation system (OPS) 9 which controls the ERP-SW 5 connects to the IP router network 8 through the router 6. Further, a Mobility Management Entity (MME) 10 which controls the base station 3 connects to the IP router network 8 through the router 6. In the meantime, the base station 3 is a base station of the Long Term Evolution (LTE), which is an example of the wireless communication standard. However, there is no restriction on the type of wireless communication standard. An SA is established between each base station 3 and the SGW 7 by using the IKEv2, and the transmission and reception (packet communication) of the ESP packet using the SA is performed between the base station 3 and the SGW 7.

<Hardware Configuration of Base Station>

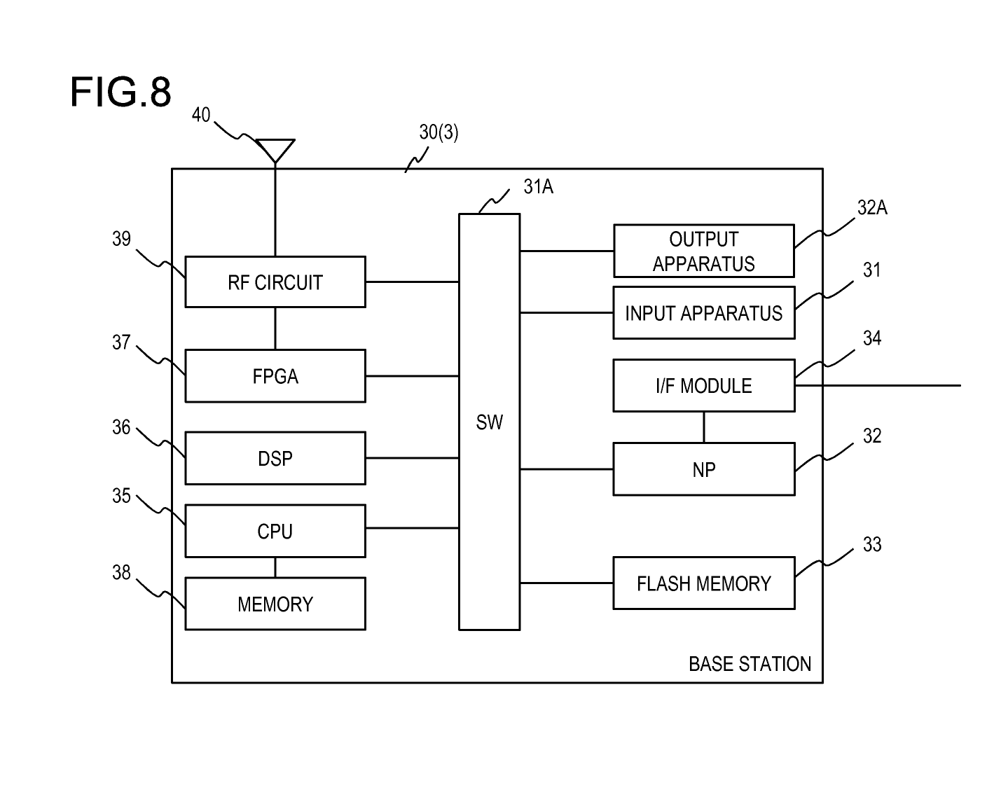

FIG. 8 is a diagram illustrating an example of a hardware configuration of a base station device 30 (hereinafter referred to as a “base station 30”) capable of being used as a base station (eNB). The base station 30 performs the processing related to a user plane (U-plane) and the processing related to a control plane (C-plane). The U-plane processing includes, for example, processing of transmitting data (user data) received from UE 1 (user) to a core network (uplink transmission) and processing of transmitting a user data received from the core network to the UE 1 (downlink transmission). The C-plane processing includes transmitting and receiving a control signal to and from the MME 10, transmitting and receiving a control signal to and from the UE 1, and controlling operations of the base station 30 using the control signal received from the MME 10 or the UE 1.

In FIG. 8, the base station device 30 includes an internal switch (SW) 31A, a network processor (NP) 32 connected to the internal switch 31A, and a flash memory 33. The NP 32 connects to an interface module 34 (I/F 34), and the I/F 34 accommodates a communication line (S1 line) connected with the MME 10 through the Ethernet 4, the SGW 7, and the IP router network 8. The NP 32 is an example of a “processor”.

The base station 30 is connected to the MME 10 through S1-MME interface of the S1 line interface. Further, the base station 30 is connected to the Serving Gateway (SPW) and Packet Data Network Gateway (PGW), which are not illustrated, through S1-U interface of the S1 line interface. The MME 10 is a node that handles the control plane (C-plane) processing, such as a position registration of the UE 1 or a bearer setup. The SGW and the PGW are nodes in the user plane (U-plane) and handle transmission of the user data (packet).

The base station 30 includes a CPU (Central Processing Unit) 35, a DSP 36, and an FPGA 37 that are connected to SW 31A. The CPU 35 connects to the memory 38. The FPGA 37 connects to an RF circuit 39 which connects to a transceiver antenna 40.

The SW 31A is responsible for the transmission and reception of signal between circuits connected to the SW 31A. The NP 32 and the I/F 34 function as line interfaces for the core network. The NP 32 performs the processing (IP protocol processing) related to an Internet Protocol (IP) packet included in signals received by, for example, the I/F 34, and an IP packet to be transmitted to the I/F 34. The I/F 34 performs, for example, processing of converting the IP packet received from the NP 32 to a signal to be transmitted to the core network or converting the signal received from the core network to the IP packet. Among the information contained in the packet received in the NP 32, information to be processed by the CPU 35 is delivered to the CPU 35 through the SW 31.

Further, the NP 32 performs the processing related to the IPsec communication. The processing related to the IPsec communication includes security policy (SP) management, SA preparation and management (including lifetime management, rekeying, and DPD), and encryption and decryption of a packet based on a security protocol (ESP in the present embodiment). Further, the NP 32 performs monitoring the communication situation regarding the communication using the SA, and storing and updating the information which indicates the communication situation.

The DSP 36 serves as a baseband (BB) processing unit which performs BB processing for the user data. The FPGA 37 serves as an orthogonal modulation/demodulation unit which performs orthogonal modulation/demodulation of the baseband signal. The RF circuit 39 performs the transmission and reception of wireless signal (radio wave) using a transceiver antenna 40.

The memory 38 is an example of a main storage device (main memory) and includes, for example, a Random Access Memory (RAM) and a Read Only Memory (ROM). The memory 38 is used as a working area of the CPU 35. A flash memory 33 is an example of an auxiliary storage device and stores data used for controlling the operation of the base station 30 or a program executed by the CPU 35 or the DSP 36.

The CPU 35 performs various processing related to the C-plane through the exchange of a control signal (control information) with the MME 10 or the UE 1. For example, the CPU 35 performs call processing for the UE 1 (attachment, incoming call, outgoing call, and detachment) or an operation administration and maintenance (OAM) processing for the base station 30. Further, the CPU 35 performs a control of transmission of synchronizing signal or notification information, or a processing related to a handover.

An input apparatus 31 includes at least one of a key, a button, a touch panel, and a microphone, and is used for inputting information. An output apparatus 32A includes at least one of a display, a lamp, a speaker, and a vibrator, and outputs information.

<Functionalities of NP>

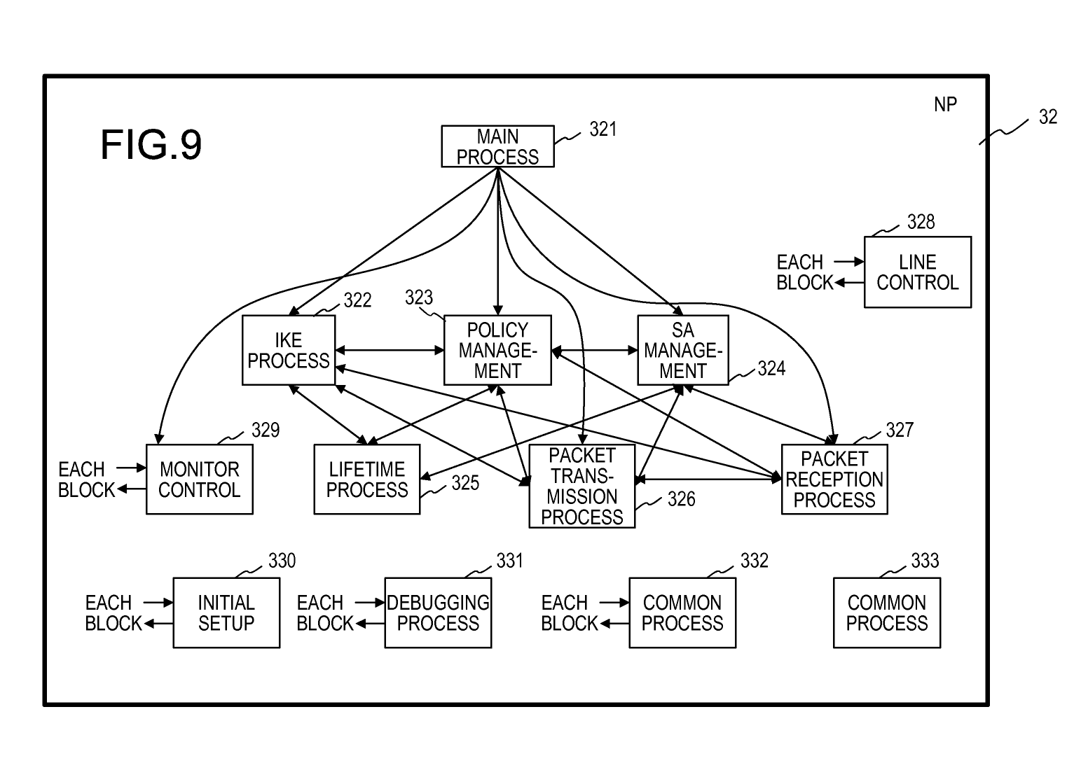

FIG. 9 is a block diagram diagrammatically illustrating functionalities of an NP 32 provided in the base station 30 (base station 3). As illustrated in FIG. 9, the NP 32 includes a storing device which is not illustrated and executes a program stored in the storing device. This allows the NP 32 to execute a main process 321, an IKE process 322, a policy management 323, an SA management 324, a lifetime process 325, a packet transmission process 326, and a packet reception process 327. Further, the NP 32 executes a line control 328, an initial setup 330, a debugging process 331, and a common process 332.

The main process 321 performs control for all the blocks (processes) of the NP 32. The line control 328, the initial setup 330, the debugging process 331, and the common process 332 may send and receive information to and from all blocks illustrated in FIG. 9.

The initial setup 330 is responsible for a resumption function of the operation of the base station 3, an FPGA download function, a diagnosis function, and a network element (NE) switching function of the base station 3. The resumption function includes an initial activation of the base station 3, clearing of SA, clearing of SPD, and notification of a support algorithm. The FPGA download function controls downloading of firmware executed by the FPGA. The diagnosis function performs a primary diagnosis or a secondary diagnosis when each card is activated in a case where the base station has a chassis type configuration (in a case of being formed by a combination of card type units). The NE switching function controls NE switching accompanying the macro or the change of status.

The IKE process 322 performs IKEv1 termination, IKEv2 termination, management of retry of an IKE message (e.g., INFORMATIONAL (DPD)). The IKE process 322 has a function of protocol (e.g., ESP) termination processing and a function corresponding to IPv4 or IPv6.

The policy management 323 manages an operation of an initiator in setting up and deleting a security policy and an operation of a responder in setting up a security policy. Further, the policy management 323 manages policy parameters and an excess of the number of policies.

The SA management 324 manages the operation of the initiator in setting up and deleting the SA, the operation of the responder in setting up and deleting the SA, the SA parameters, and the excess of the number of SAs.

The lifetime process 325 performs an activation (start) of the lifetime (of hard lifetime and the soft lifetime) when setting up the SA, and rekeying when the soft lifetime has exceeded a timer (time set in the timer has expired). Further, the lifetime process 325 performs the deletion of the SA when the hard lifetime has exceeded a timer (time set in the timer has expired), setting up of a life byte when setting up the SA, and rekeying at the time when the soft life byte is exceeded. The management of the lifetime may be performed by at least one of a time management using a timer or management using the number of bytes of packets to be transmitted. The life byte indicates a lifetime managed by the number of bytes of packets to be transmitted.

The packet transmission process 326 performs a control of transmission and reception of packets to be transmitted to the SGW 7 (higher-level apparatus), counting the number of abandoned packets, an abandonment of the packet when detecting overflow of a transmission sequence number (SN), and rekeying.

The packet receive process 327 performs, for example, a control of transmission and reception of packets received from the SGW 7 (higher-level apparatus) and counting the number of abandoned packets.

The monitor control 329 perform a reset control (control of a macro related to resetting), monitoring and reporting (monitoring and controlling of a macro related to monitoring/reporting and call processing), a card control (control of the macro controlling its own card), collecting changes in a card status (control of collecting changes in statuses of its own card and other card).

The common process 332 performs the processing common to the constitutional units within the base station 3. The common process 332 includes, for example, a timer function, a relay function of a packet or signal, a watchdog timer ((WDT): a hardware time measuring equipment in a computer) function, and a common function group.

The debugging process 331 includes a function of logging a fault log or executing a command necessary for debugging. The line control 328 performs terminating of the communication with the CPU 35 and receiving and delivering of the intra-apparatus message (setting up system parameter/path).

The NP 32 is an example of a “monitoring unit,” a “determination unit,” and a “control unit.” The memory 333 is an example of a “storing unit.”

<SA Information Management Table>

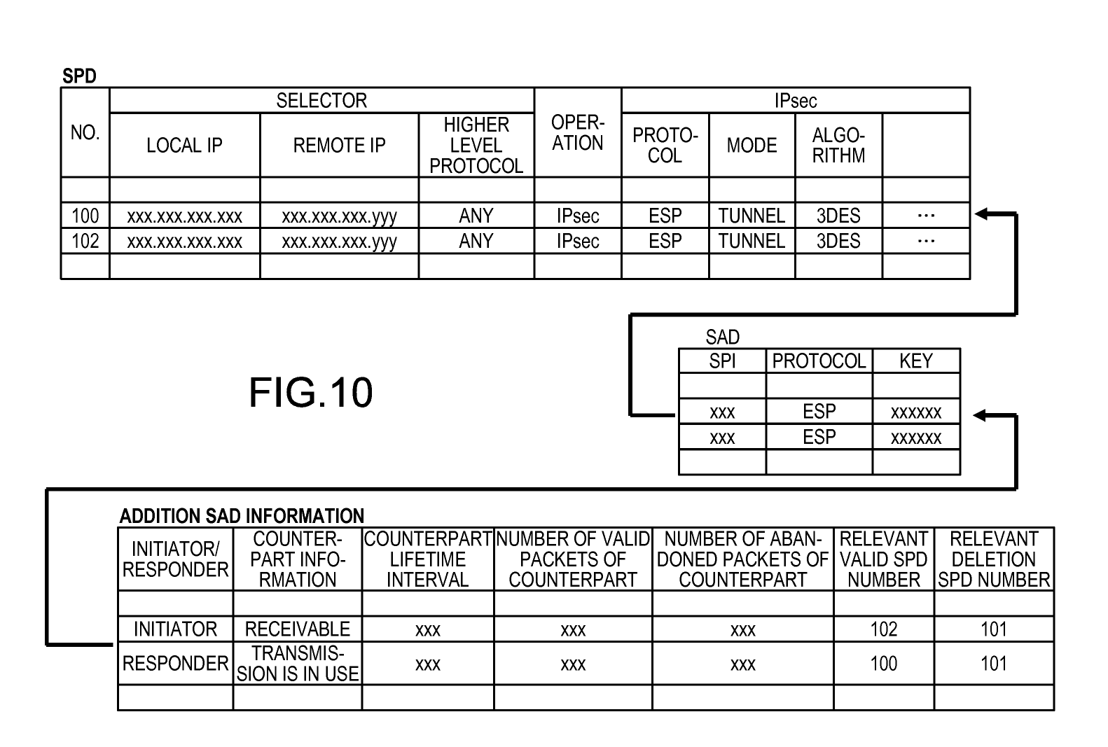

FIG. 10 is a diagram illustrating an example of data structures of an SA information management table. The SA information management table corresponds to the SA information table illustrated in FIG. 6B. The SA information management table includes a security policy database (SPD), a security association database (SAD), and an addition SAD information table (hereinafter referred to as an “addition SAD”).

The SPD includes a “management number (SPD number),” a “selector,” an “operation,” and an “IPsec.” The “management number (SPD number)” is used as identification information of an entry (record) of the SPD. The “selector” stores at least a set of local IP, a remote IP, and a higher level protocol. The set is handled as a target for which the security policy is to be set. The local IP indicates an IP address of the base station 3 and the remote IP indicates an IP address of the SGW 7. The higher level protocol indicates any protocol (“ANY”) in the example of FIG. 10.

The “operation” indicates a type of operation for the communication between the local IP and the remote IP, and is set to indicate that the IPsec communication is performed, in the example of FIG. 10. The “IPsec” includes parameters indicating contents of the IPsec communication. The parameters, such as a “protocol”, a “mode,” and an “algorithm”, are included in the example of FIG. 10. The “protocol,” “mode,” and “algorithm” indicates types of a protocol, mode, algorithm used in the IPsec, respectively. In FIG. 10, the ESP is set as the “protocol,” a tunnel mode is set as “mode,” and 3DES is set as the “algorithm”.

The record (entry) for each SA established between the base station 3 and the SGW 7 is stored in the SAD. The entry includes the “SPI (a set of bidirectional SPIs),” the “protocol,” the “key information”. However, although not illustrated, an SA lifetime is stored in the SAD. The entry of the SAD is added when the SA is established, and linked to a corresponding entry of the SPD. The SAD corresponds to the SA information table illustrated in FIG. 6B and FIG. 6C.

The addition SAD stores information indicating a communication situation of the communication being made using each SA. The addition SAD includes the entry for each SA in the example illustrated in FIG. 10. The entry includes “initiator/responder,” “counterpart information,” “counterpart lifetime interval,” “number of valid packets of counterpart,” and “number of abandoned packets of counterpart.” Further, the entry includes a “relevant valid SPD number” and a “relevant deletion SPD number.” The information stored in the addition SAD is an example of “information indicating a communication situation of each of a plurality of security associations.”

The “initiator/responder” is a flag for determining whether a role of the base station for a managing target SA is an initiator or a responder. For example, when a value of the flag is “0,” the flag indicates the initiator and otherwise, when the value of the flag is “1,” the flag indicates the responder.

The “counterpart information” indicates a state of the counterpart apparatus (SGW 7). For example, the “counterpart information” may be represented by a 3-bit. A first bit (lower most bit) indicates whether the counterpart apparatus is able to receive the packet from the base station 3 (“1”) or unable to receive the packet (“0”). A second bit indicates whether the counterpart apparatus uses the SA as a transmission SA to the base station (“1”) or does not uses as the transmission SA (“0”). A third bit indicates whether an abnormality is detected by the DPD (“1”) or is not detected (“0”). The state and the bit value described above are illustrative and may be set to illustrate a state and bit value contrary to those described above.

The “counterpart lifetime interval” indicates an interval at which a rekeying request is notified from the counterpart apparatus. For example, the interval (time length) and date and time at which the rekeying request is notified (date and time of the last rekeying) are stored as the “counterpart lifetime interval”.

The “number of valid packets of counterpart” indicates the number of valid packets received from the counterpart apparatus. For example, a count value of the valid packets received within a predetermined time is stored as the “number of valid packets of counterpart” at each predetermined time. A length of the predetermined time may be appropriately set.

The “number of abandoned packets of counterpart” indicates the number of abandoned packets among the packets received from the counterpart apparatus. For example, a count value of the packets abandoned within a predetermined time is stored as the “number of abandoned packets of counterpart” at each predetermined time. The predetermined time may be appropriately set. For example, a time length which is the same as the predetermined time set in the “number of valid packets of counterpart” may be employed.

In the packet reception process 327, a determination as to whether a packet is valid or invalid is performed for each packet received from the counterpart apparatus and the packet determined as invalid is abandoned. Also, the packet receive process 327 finds out a corresponding entry of the SA information management table by using the SPI assigned to each packet and updates the “number of valid packets of counterpart” and the “number of abandoned_packets of counterpart.” The update processing is executed for the “number of valid packets of counterpart” and the “number of abandoned packets of counterpart” in the SA information management table as well as in a preserving management table, which will be described below.

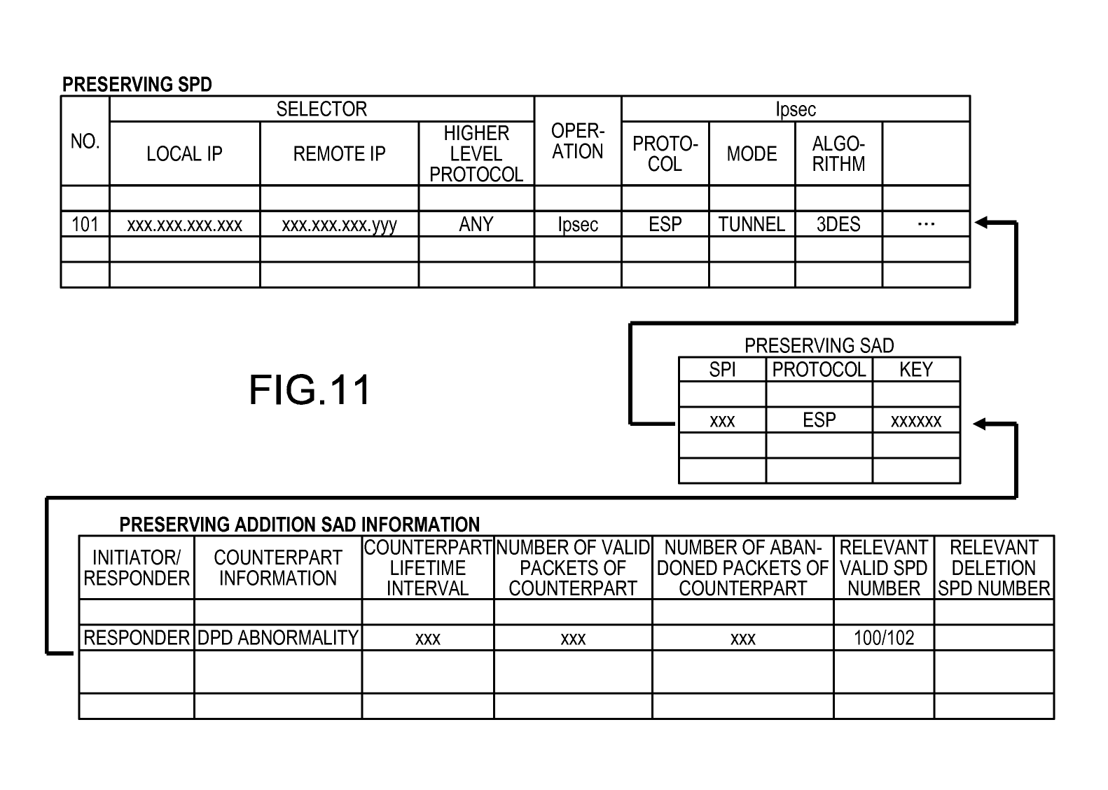

The “relevant valid SPD number” is an entry related to the entry described above and indicates the SPD number of the entry of which the SA is valid (being established). The “relevant deletion SPD number” is an entry related to the entry described above and indicates the SPD number of an entry deleted from the SPD and stored in a preserving SPD (FIG. 11).

<Preserving Management Table>

FIG. 11 is a diagram illustrating an example of a data structure of a preserving management table. The preserving management table corresponds to the SA information preservation table illustrated in FIG. 6B. The preserving management table includes a preserving SPD, a preserving SAD, and a preserving addition SAD information table (preserving addition SAD). A data structure of each of the preserving SPD, the preserving SAD, and the preserving addition SAD is the same as each of the SPD, the SAD, and the addition SAD illustrated in FIG. 10, respectively. The entry of abandoned SA is stored (preserved) in the preserving SPD, the preserving SAD, and the preserving addition SAD.

The entry of the preserved SA is kept in a preserved state until the lifetime set to the preserved SA expires. The entry of which the lifetime expires is deleted from the preserving management table. Further, the monitoring of the communication situation regarding the preserved SA is continued and the “number of valid packets of counterpart” and the “number of abandoned packets of counterpart” in a preserving addition SAD table are appropriately updated.

The SA information management table and preserving management table described above are stored in the memory 333 (see, e.g., FIG. 9) provided in the NP 32. However, the SA information management table and the preserving management table may be stored in the memory (e.g., the flash memory 33) accessible by the NP 32 other than the memory 333. The memory 333 is, for example, a semiconductor memory including a volatile region and a non-volatile region. The memory 333 is an example of a “computer readable recording medium.”

In the meantime, FIG. 10 and FIG. 11 illustrate a case where deletion of the security policy between the counterpart apparatuses is also performed according to an establishment and abandonment of the SA. When the security policy does not vary depending on the establishment and abandonment of the SA, a configuration may be employed in which the preserving SAD and the preserving addition SAD are prepared as a preserving management table and the preserving SAD is linked to the SPD.

<Processing in Base Station>

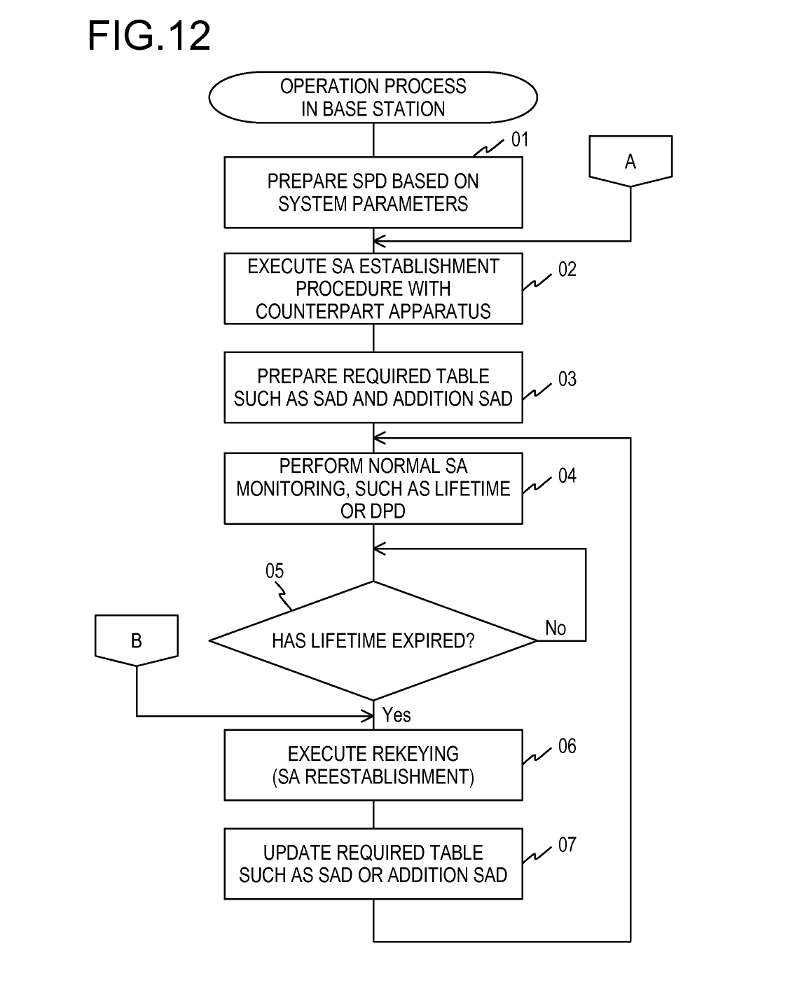

Next, descriptions will be made on processes to be performed in the base station 30 (hereinafter denoted by a “base station 3”) with reference to flowcharts of FIG. 12 through FIG. 20. In the embodiment, the NP 32 executes a program so as to perform a process illustrated in each flowchart. However, the program may be executed by other processor such as the CPU 35. Otherwise, the processes may be performed through cooperation with a plurality of processors (executors for the processes) such as the NP 32 and the CPU 35. In the meantime, the program executed by the NP 32 is stored in, for example, the memory 333 or the flash memory 33 provided in the NP 32.

In the meantime, in order to simplify the description, it is assumed that the expiration time of the lifetime set in the SGW 7 is later than the expiration time of the lifetime set in the base station 3, for each of the plurality of SAs established between the base station 3 and the SGW 7.

<<Operation and Management of Base Station>>

FIG. 12 is an operational flowchart illustrating an example of an operation and management of the base station 3. The NP 32 performs the initial setup 330 and prepares the SPD (FIG. 10) based on the system parameters in the first processing at Step 01. The processing at Step 01 is performed by, for example, the policy management 323. In the processing at Step 02, the NP 32 executes a procedure for establishing the SA with the counterpart apparatus (SGW 7) (see FIG. 1) for the packet communication using the IPsec between the end devices (hosts). The processing at Step 02 is performed by, for example, the IKE process 322.

In the processing at Step 03, the NP 32 prepares a table for the SA management, such as the SAD and addition SAD (FIG. 10), and a table used for monitoring a communication situation using the SA. The processing at Step 03 is performed by, for example, the SA management 324. Thereafter, the NP 32 starts a normal SA monitoring process, such as the lifetime monitoring of SA and the DPD (Step 04). The lifetime monitoring is performed by, for example, the lifetime process 325, and the DPD is performed by, for example, the SA management 324.

In the monitoring of SA, the NP 32 determines whether the lifetime of the SA has expired (Step 05). In this case, when it is determined that the lifetime has expired (“YES” at 05), the NP 32 executes rekeying of the SA of which the lifetime has expired between the NP 32 and the counterpart apparatus (SGW 7) and performs the reestablishment (re-creation) of the SA (Step 06). The NP 32 updates the SAD and the addition SAD according to the rekeying (Step 07). Thereafter, the process goes back to Step 04.

<<Table Update #1>>

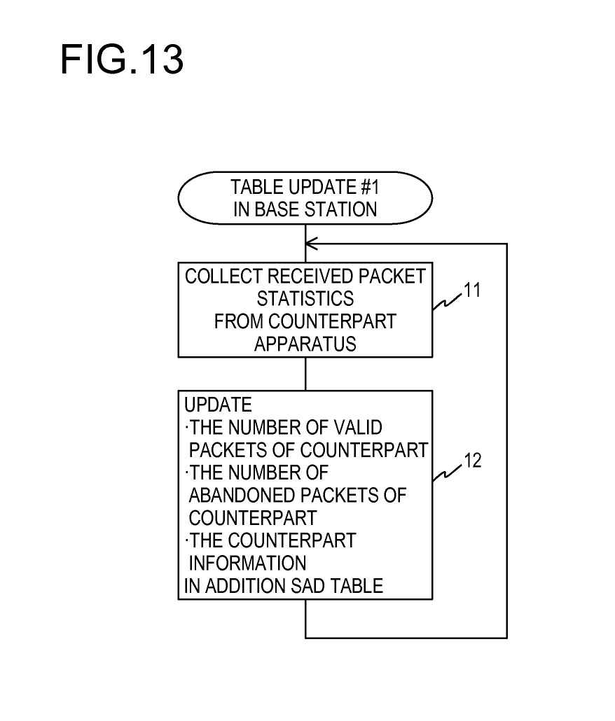

FIG. 13 is an operational flowchart illustrating an example of a first table update process (table update #1) in the base station 3. The process illustrated in FIG. 13 is executed, for example, in parallel with other processing or as an interruption processing with respect to other processing, after Step 03 of FIG. 12. In the processing at Step 11 of FIG. 13, the NP 32 collects statistical information about the received packets from the counterpart apparatus. The NP 32 updates, in the addition SAD, the number of valid packets of counterpart, the number of abandoned packets of counterpart, and the counterpart information. (Step 12) The processing at Step 11 and Step 12 are performed by, for example, the packet reception process 327. The process goes back to Step 11 after the processing at Step 12.

For example, when the number of valid packets of counterpart is one or more for the SA for which the base station 3 is the responder, the counterpart information has a value indicating that a “transmission is in use”, and when the number of valid packets of counterpart is zero, the counterpart information has a value indicating that a “transmission is not being used.”

<<Table Update #2>>

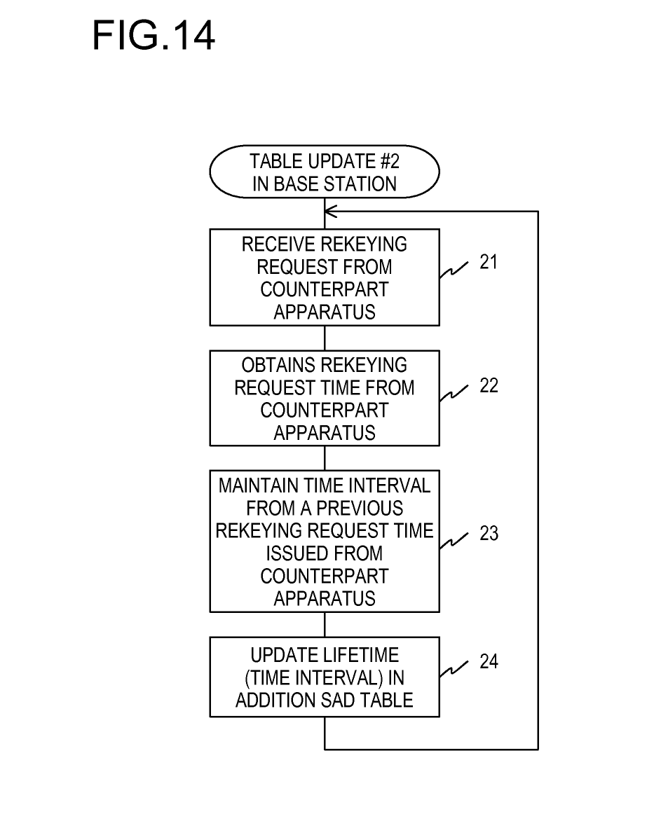

FIG. 14 is an operational flowchart illustrating an example of a second table update process (table update #2) in the base station 3. The process is started when a rekeying request message for a certain SA is received from the counterpart apparatus (SGW 7) (Step 21) after Step 03 of FIG. 12. The process illustrated in FIG. 14 is performed by, for example, the IKE process 322 and the lifetime process 325.

In the processing at Step 22, the NP 32 obtains a time of the rekeying request issued from the counterpart apparatus (SGW 7). For example, the NP 32 obtains a reception time of the rekeying request. In the processing at Step 23, the NP 32 obtains a time interval between a time of the previous rekeying request issued (reception time of the previous rekeying request) and a reception time of the current rekeying request from the counterpart apparatus (SGW 7) as a lifetime of the certain SA. In the processing at Step 24, the NP 32 stores (updates) the lifetime (time interval) as one of the parameters to be stored in the addition SAD information table. Thereafter, the process goes back to Step 21 and the NP 32 is placed in a waiting state for the rekeying request.

<<Counterpart Apparatus Monitoring #1>>

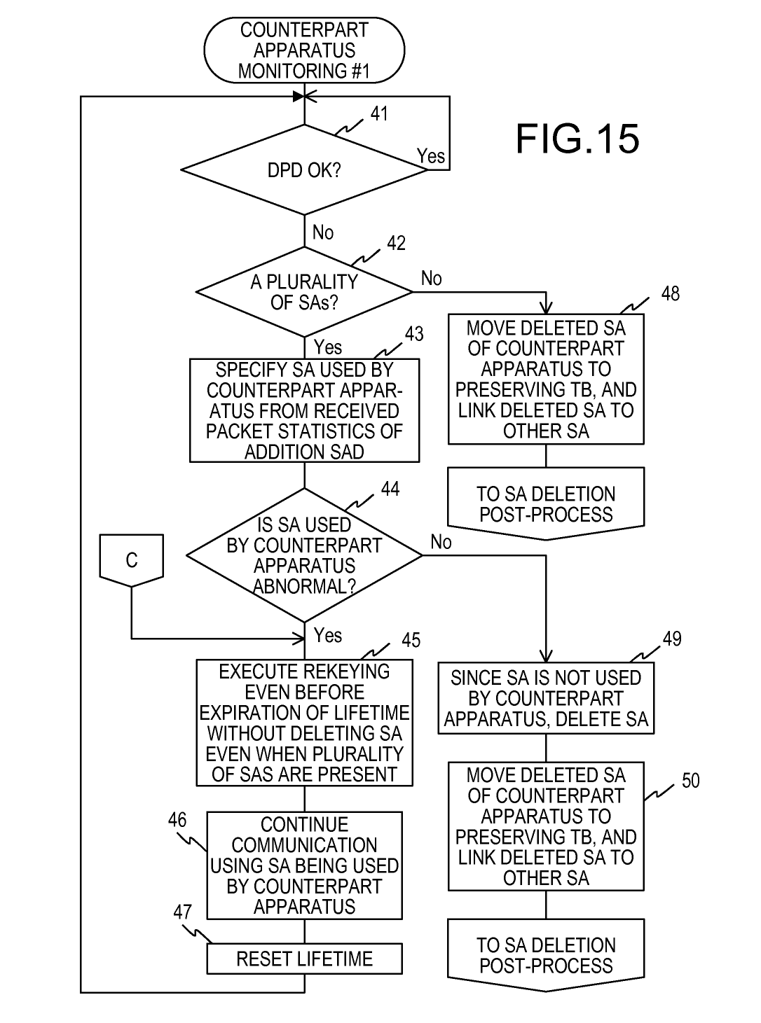

FIG. 15 is an operational flowchart illustrating an example of a first counterpart apparatus monitoring process (counterpart apparatus monitoring #1) in the base station 3. In the processing at Step 41 of FIG. 15, the NP 32 executes DPD and determines whether a response message is received from the counterpart apparatus (SGW 7). The transmission of a DPD message is executed at, for example, regular intervals. When it is determined that the response message is received, the process goes back to Step 41. In the meantime, when the response message to the DPD is not received, the SA is determined as being disconnected and the process proceeds to Step 42. The processing at Step 41 is performed by, for example, the IKE process 322. In this case, a value indicating that “DPD: abnormality is present” is set in the counterpart information in the addition SAD.

In the processing at Step 42, the NP 32 determines whether a plurality of SAs are established with the counterpart apparatus (SGW 7). For example, when a plurality of entries each of which has a value indicating the same selector are present in the SPD, the NP 32 determines that the plurality of SAs are established, and the process performed by the NP 32 proceeds to Step 43. In the meantime, when the entry having a value indicating that the same selector is not present, the NP 32 determines that a plurality of SAs are not established, the process proceeds to Step 06 (FIG. 12), and rekeying is executed.

In the processing at Step 43, the NP 32 refers to the addition SAD and finds out the entry which corresponds to the disconnected SA. For example, the NP 32 detects the entry having the SPI of the disconnected SA.

In the processing at Step 44, the NP 32 determines whether the SA detected as having been disconnected is the SA being used by the SGW 7. That is, the NP 32 refers to the addition SAD and determines whether the counterpart information in the entry of the SA detected as having been disconnected indicates the “transmission is in use.” In this case, when it is determined that the counterpart information indicates that the “transmission is in use,” the process proceeds to Step 45. In the meantime, when the counterpart information indicates that the “transmission is not being used,” the process proceeds to Step 49.

In the processing at Step 45, the NP 32 executes rekeying for the SA being used by the counterpart apparatus (SGW 7) without deleting the SA detected as having been disconnected even when the plurality of SAs are present between the base station and the counterpart apparatus (SGW 7). The rekeying may be executed even before the lifetime of a rekeying target SA expires.

The communication is continued using the SA being used by the counterpart apparatus (SGW 7) by rekeying (Step 46). The NP 32 resets the lifetime for the SA reestablished by rekeying (Step 47). When the processing at Step 47 is ended, the process goes back to Step 41.

For example, it is assumed that two SAs (SA1 and SA2) are established between the base station 3 and the SGW 7, disconnection of the SA2 is detected by the base station 3, and the SA2 is used by the SGW 7. In this case, rekeying for the SA2 is executed in the processing at Step 45. With rekeying of the SA2 (update of a key of CHILD_SA), the communication status between the base station 3 and the SGW 7 is restored to a normal status at an earlier time than a case of being waited until the lifetime of the SA1 expires.

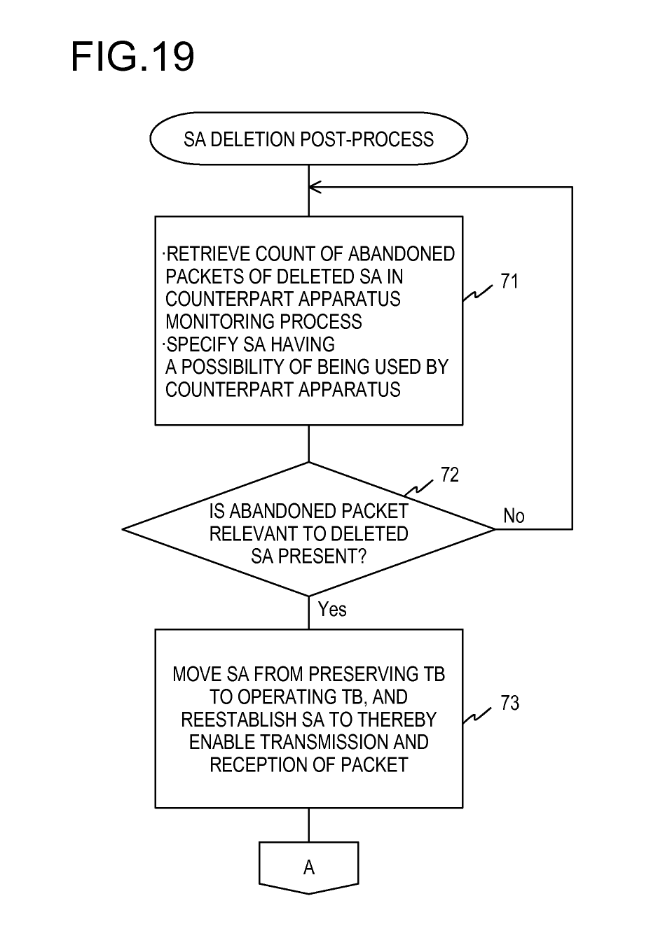

When the process has proceeded to Step 48, the NP 32 deletes the entry of the SA detected as having been disconnected, from the SA information management table, so as to be stored in the preserving management table. In this case, a procedure for establishing a new SA with the counterpart apparatus (SGW 7) is executed and the communication is made between the base station 3 and the counterpart apparatus (SGW 7) by using the new SA. However, the NP 32 stores the deleted entry in the preserving management table (FIG. 11) in preparation for a case where the counterpart apparatus (SGW 7) makes communication using the SA detected as having been disconnected. Thereafter, the process proceeds to an SA deletion post-process (FIG. 19).

When the process proceeds to Step 49, since the disconnected SA is a SA which is not being used by the counterpart apparatus (SGW 7), the NP 32 abandons the SA. That is, the NP 32 deletes the entry of the SA from the SA information management table (FIG. 10).

Next, the NP 32 stores the deleted entry in the preserving management table (FIG. 11) and links the deleted entry to the other SA entry stored in the SA information management table (Step 50). For example, it is assumed that the entries of the SAs having the SPD numbers of “100,” “101,” and “102” are stored in the SA information management table illustrated in FIG. 10. When the disconnection of the SA having the SPD number of “101” is detected and the entry of the SPD number of “101” is determined as having been deleted, a processing of moving the entry of the SPD number of “101” from the SA information management table to the preserving management table (FIG. 11) is executed. In this case, the SPD number of “101” of the deleted entry is stored in the “relevant deletion SPD number” in each of the entries of the SPD numbers of “100” and “102” stored in the addition SAD of the SA information management table. In the meantime, the SPD numbers of “100” and “102” are stored in the “relevant valid SPD number” in the preserving addition SAD. The linking of entries is implemented by associating the deleted SPD number with the valid SPD number. When the processing at Step 50 is ended, the process proceeds to the SA deletion post-process (FIG. 19).

<<Counterpart Apparatus Monitoring #2>>

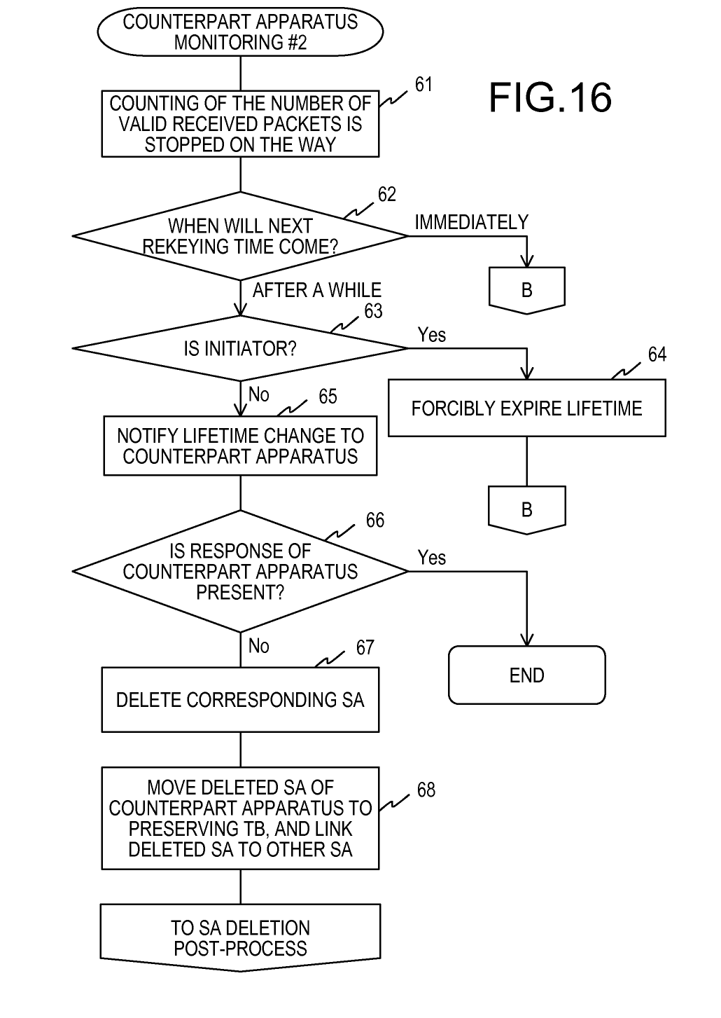

FIG. 16 is an operational flowchart illustrating an example of a second counterpart apparatus monitoring process (counterpart apparatus monitoring #2) in the base station 30 (base station 3). The process illustrated in FIG. 16 is executed for the target SA being used by the counterpart apparatus (SGW 7) whenever a predetermined time elapses. The predetermined time is set, for example, in accordance with a predetermined time used for counting the number of valid packets received.

In the processing at Step 61, the NP 32 refers to the addition SAD for the target SA and determines whether the number of valid packets received within the predetermined time is zero. When it is determined that the number of valid packets received is zero, the NP 32 detects that receiving of the valid packets (an example of “communications from counterpart apparatus”) has stopped on the way. Then, the NP 32 refers to the SAD or the addition SAD to confirm a next rekeying time for the SA, that is, a lifetime expiration time.

The NP 32 determines whether the rekeying time (that is, expiration time of lifetime) will come within a predetermined time period. When it is determined that the rekeying time will come within the predetermined time period (“immediately” at Step 62), the NP 32 waits until the lifetime expires and the process proceeds to Step 06 (FIG. 12). In the meantime, when it is determined that the rekeying time will not come within the predetermined time period (“after a while” at Step 62), the process proceeds to Step 63.

In the processing at Step 63, the NP 32 determines whether the base station 30 is the initiator or the responder for the target SA. The determination is made by referring to the “initiator/responder” in the entry of the target SA of the addition SAD. When the base station 30 is the initiator (“Yes” at Step 63), the NP 32 forcibly expires the lifetime of the target SA (Step 64), and the process performed by the NP 32 proceeds to Step 06 (FIG. 12).

In contrast, when the base station 30 is the responder (“No” at Step 63), the NP 32 performs a processing of generating a message of a lifetime change notification to the counterpart apparatus (SGW 7) to transmit the message to the counterpart apparatus (SGW 7) (Step 65).

The lifetime notified to the counterpart apparatus is determined as in the following manner. For example, the NP 32 refers to the “counterpart lifetime interval” of the target SA in the addition SAD and estimates a next lifetime expiration time in the counterpart apparatus (SGW 7). Next, the NP 32 compares the estimated lifetime expiration time with the lifetime expiration time (stored in the SAD) of the target SA in the base station 3. The NP 32 determines the lifetime of the target SA in the counterpart apparatus (SGW 7) which expires earlier than the lifetime of the base station 3. The lifetime determined as described above is included in the lifetime change notification.

When the lifetime change notification is received, the counterpart apparatus (SGW 7) executes the change (reduction) of lifetime of the target SA and replies the response message for the lifetime change notification to the base station 3.

When the response message for the lifetime change notification is received from the counterpart apparatus (SGW 7) (“Yes” at Step 66), the NP 32 ends the process of FIG. 16. This is because the counterpart apparatus (SGW 7) transmits a rekeying message (CREATE_CHILD_SA request) for the target SA according to the expiration of lifetime of the target SA.

In the meantime, when the response message to the lifetime change notification is not received from the counterpart apparatus (SGW 7) (“No” at Step 66), the NP 32 deletes the entry of the target SA from the SA information management table (Step 67) and stores the entry of the target SA in the preserving management table (Step 68). In this case, the deleted entry is linked to other SA entry which is present in the SA information management table as needed. Thereafter, the process proceeds to the SA deletion post-process (FIG. 19).

### Modified Example

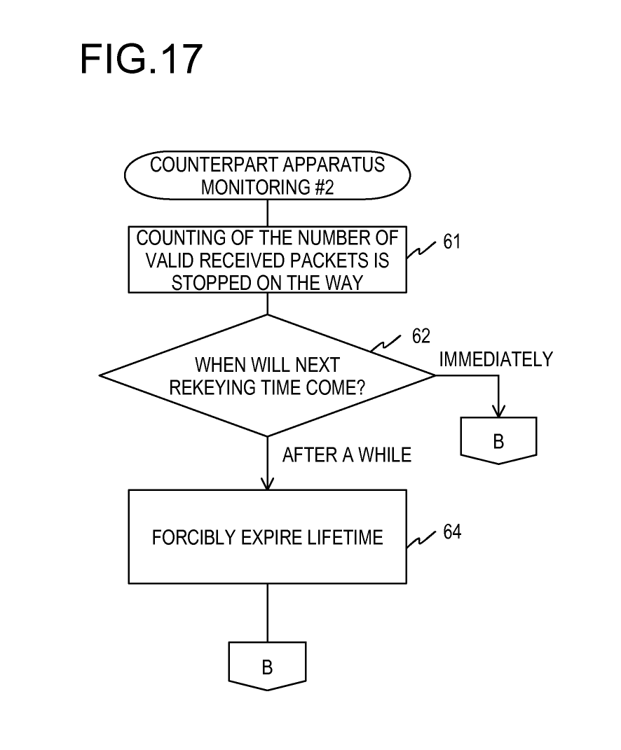

A second counterpart apparatus monitoring process (counterpart apparatus monitoring #2) illustrated in FIG. 16 may be modified as follows. In the example illustrated in FIG. 16, descriptions have been made on the process in which the matters of whether the base station 3 serves as the initiator or the responder in establishing the target SA is taken into account. But, in the IKEv2, one peer having an expiration time of lifetime earlier than that of the other peer among the peers between which the SA is established may execute rekeying. In other words, rekeying (transmission of CREATE_CHILD_SA request) may be initiated by either the initiator or the responder of the IKE_SA. Accordingly, the process of FIG. 16 may be modified as in the process of FIG. 17.

FIG. 17 is an operational flowchart illustrating Modified example 1 of the second counterpart apparatus monitoring process (counterpart apparatus monitoring #2). In the processing at Step 62 of FIG. 17, when it is determined that the next rekeying time is “after a while”, that is, the lifetime expiration time of the target SA in the base station 3 is longer than the predetermined time (“after a while” at 62), the NP 32 forcibly expires the lifetime of the target SA and the process performed by the NP 32 proceeds to Step 06 (FIG. 12).

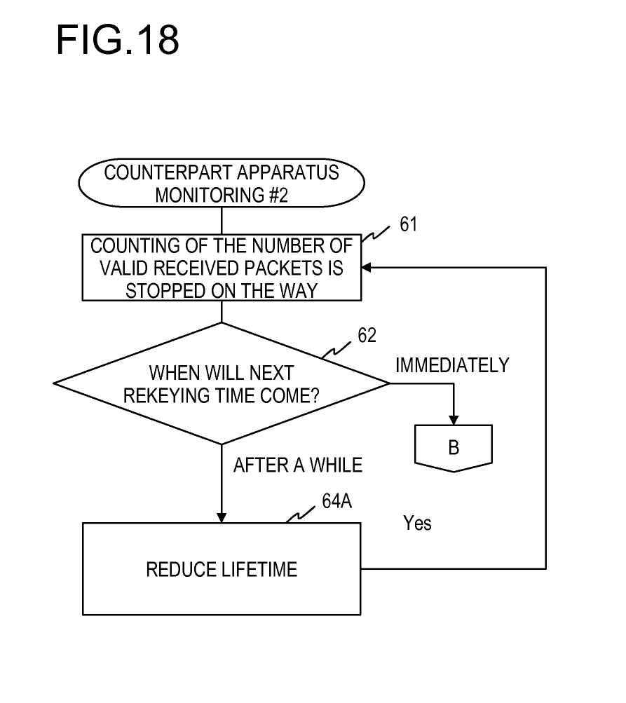

FIG. 18 is an operational flowchart illustrating Modified example 2 of the second counterpart apparatus monitoring process (counterpart apparatus monitoring #2). In the processing at Step 62 of FIG. 18, when it is determined that the next rekeying time is “after a while,” that is, the lifetime expiration time of the target SA is longer than a predetermined time, the NP 32 reduces the lifetime of the target SA by a predetermined time (Step 64A), and the process performed by the NP 32 goes back to Step 61. An amount of the predetermined time to be reduced at Step 64A may be appropriately set. With the processing at Step 64A, it is possible to make an expiration timing of lifetime earlier.

<<SA Deletion Post-Process>>

FIG. 19 is an operational flowchart illustrating an example of an SA deletion post-process. The SA deletion post-process of FIG. 19 targets, for example, the SA (SA deleted from the SA information management table and referred to as “deletion SA”) of which the entry is stored in the preserving management table, and is regularly executed. In the processing at Step 71 of FIG. 19, the NP 32 refers to the number of abandoned packets of counterpart in the preserving addition SAD and determines whether the number of abandoned packets of counterpart is zero (Step 72).

Here, when it is determined that the number of abandoned packets of counterpart is zero (“No” at Step 72), it means that the packet using the deletion SA is not being transmitted from the counterpart apparatus (SGW 7). Accordingly, the process performed by the NP 32 returns to Step 71. In the meantime, when the number of abandoned packets of counterpart is not zero (“Yes” at Step 72), it means that packets using the deleted SA are transmitted from the counterpart apparatus (SGW 7) and received in the base station 3, but are abandoned since the packets are unable to be decrypted.

Therefore, the NP 32 moves the entry of the deletion SA from the preserving management table (preservation TB) to the SA information management table (operating TB) (Step 73) and executes the reestablishment of SA according to the deletion SA (Step of 02 FIG. 12). Accordingly, the base station 3 becomes able to receive the packet from the counterpart apparatus (SGW 7).

As described above, the information (entry) about the abandoned SA is preserved in the preserving management table, and when the packet reception using the abandoned SA is detected, the reestablishment of SA (update of a key by CREATE_CHILD_SA) is performed using the preserved information. In the reestablishment of SA described above, an existing IKE_SA may be used and thus the communication may be restored earlier than a case of establishing a new SA.

In the meantime, in the description of the example of operations using the flowchart, the operations of the base station 3 (NP 32) at the time when the disconnected SA is detected are not always coincident with the operations of the base station in Embodiments 1 to 4. However, it is common that the communication between the base station and the counterpart apparatus (a higher-level apparatus, e.g., SGW 7) is restored to a normal state due to rekeying (reestablishment of SA) or the establishment of the new SA by the base station 3. The configuration of the base station 30 (base station 3) described in Embodiment 5 may be applied to Embodiments 1 to 4. In other words, the operations of the base stations in Embodiments 1 to 4 may be performed using the configuration of the base station 30 (base station 3) described in Embodiment 5, Embodiments 1 to 4.

<Effects of Embodiments>

According to Embodiments 1 to 5, the information which indicates the situation of communication which uses each of the plurality of SAs established between the communication apparatus (base station) and the counterpart apparatus (higher-level apparatus, that is, SGW 7) is stored in the addition SAD. Also, when any one of the plurality of SAs is disconnected, it is determined whether the disconnected SA is an SA being used by the counterpart apparatus. When it is determined that the disconnected SA is being used by the counterpart apparatus, the base station conducts the reestablishment (SA update by rekeying or new SA establishment) of an SA which supersedes the disconnected SA. With the reestablishment of SA, the counterpart apparatus is placed in a state of making communication using the reestablished SA. Accordingly, the communication state may be restored to a normal state at an earlier time than a case of waiting until the lifetime of the SA expires in one of the communication apparatus and the counterpart apparatus.

Further, rekeying may be adapted to be executed by forcibly expiring the lifetime or reducing the lifetime according to Embodiments 4 and 5. In this case, since rekeying may be executed not by an interruption processing for the rekeying but by changing the lifetime, the modification amount to the existing program (man hour required for development) is reduced.

Further, according to the SA deletion post-process_in Embodiment 5, when the disconnected SA is abandoned (deleted) by the base station, the information about the deletion SA is stored in the preserving management table. Thereafter, when the reception of packet using the deletion SA is detected, the information about the deletion SA of the preserving management table is moved to the SA information management table and the deletion SA is reestablished by rekeying such that an SA which supersedes the deletion SA may be established at an earlier time than in a case of establishing a new SA.

The configurations of the embodiments described above may be appropriately combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to an illustrating of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for controlling communication performed by a communication apparatus, the method comprising:
monitoring, by the communication apparatus, a communication situation of a communication performed using each of a plurality of security associations established between the communication apparatus and a counterpart apparatus, and storing first information indicating the communication situation;
when a first security association in the plurality of security associations is disconnected, determining, by the communication apparatus, whether the counterpart apparatus uses the disconnected first security association, based on the first information; and
when the counterpart apparatus uses the first security association, reestablishing, by the communication apparatus, a second security association which supersedes the first security association.

2. The method of claim 1, wherein
the reestablishing of the second security association is conducted, by the communication apparatus, through an update of the first security association.

3. The method of claim 1, wherein
the reestablishing of the second security association is conducted, by the communication apparatus, through an update of one of the plurality of security associations being established with the counterpart apparatus other than the first security association.

4. The method of claim 1, wherein
the reestablishing of the second security association is conducted, by the communication apparatus, through an establishment of a new security association which supersedes the first security association.

5. The method of claim 1, wherein
a lifetime of one of the plurality of security associations is forcibly expired by the communication apparatus when the counterpart apparatus is using the first security association.

6. The method of claim 1, wherein
a lifetime of one of the plurality of security associations is reduced by the communication apparatus when the counterpart apparatus is using the first security association.

7. The method of claim 1, wherein
the communication situation of a third security association being used by the counterpart apparatus is monitored by the communication apparatus, and a lifetime of the third security association is forcibly expired by the communication apparatus when a communication from the counterpart apparatus using the third security association is disconnected for a predetermined period of time.

8. The method of claim 1, wherein
the communication situation of a third security association being used by the counterpart apparatus is monitored, and a lifetime of the third security association is reduced by the communication apparatus when a communication from the counterpart apparatus using the third security association is disconnected for a predetermined period of time.

9. The method of claim 1, further comprising
preserving, by the communication apparatus, second information about a security association that has been abandoned due to the reestablishing of the second security association; and
reestablishing, by the communication apparatus, the abandoned security association by using the preserved second information when a communication from the counterpart apparatus using the abandoned security association is detected based on the first information indicating the communication situation.

10. A communication apparatus comprising:
a processor coupled to a memory, the processor being configured:
to monitor a communication situation of a communication performed using each of a plurality of security associations established between the communication apparatus and a counterpart apparatus, and store information indicating the communication situation in the memory,
to, when a first security association in the plurality of security associations is disconnected, determine whether the counterpart apparatus uses the disconnected first security association, based on the information, and
to, when the counterpart apparatus uses the first security association, reestablishing, reestablish a second security association which supersedes the first security association; and
the memory configured to store the information indicating the communication situation.

11. A system comprising:
a communication apparatus; and
a counterpart apparatus configured to communicate with the communication apparatus by using a security association, wherein
the communication apparatus is configured:
to monitor a communication situation of a communication performed using each of a plurality of security associations established between the communication apparatus and a counterpart apparatus, and store information indicating the communication situation,
to, when a first security association in the plurality of security associations is disconnected, determine whether the counterpart apparatus uses the disconnected first security association, based on the information, and
to, when the counterpart apparatus uses the first security association, reestablishing, reestablish a second security association which supersedes the first security association.
